(19) United States
(12) Patent Application Publication
(10) Pub. No.: US 2012/0133690 A1
(43) Pub. Date: May 31, 2012

(54) DISPLAY ELEMENT AND ELECTRICAL DEVICE

(76) Inventor: Takashi Katayama, Osaka-shi (JP)

(21) Appl. No.: 13/389,332

(22) PCT Filed: Mar. 2, 2010
(86) PCT No.: PCT/JP2010/053325

§ 371 Date: Feb. 7, 2012

(30) Foreign Application Priority Data
Aug. 7, 2009 (JP) 2009-184250

(51) Int. Cl. G09G 3/36; G02B 26/00; G02F 1/137; G09G 5/02

(52) U.S. Cl. 345/690; 359/290; 349/167; 345/88

(57) ABSTRACT

A display element (2) includes: a soft material (24) enclosed within a display space (K) in an expandable and/or contractable manner, the display space (K) being formed between an upper substrate (first substrate) (5) and a lower substrate (second substrate) (6); and a counter electrode (second electrode) (22) and a pixel electrode (first electrode) (21) provided on the upper substrate (5) side and the lower substrate (6) side, respectively. The display element changes the display color on the display surface by causing the soft material (24) to expand and/or contract in a predetermined direction in response to an electric field generated between the pixel electrode (21) and the counter electrode (22).

### TECHNICAL FIELD

The present invention relates to a display element capable of changing a display color by applying a voltage to a soft material such as a liquid crystal elastomer, and to an electrical device using the display element.

### BACKGROUND ART

In recent years, liquid crystal display devices have been used widely in liquid crystal display televisions, monitors, mobile phones and the like as flat panel displays having advantages over conventional cathode-ray tubes such as being thin and lightweight. Such a liquid crystal display device displays information such as characters and images by changing, in response to a voltage applied to a liquid crystal layer, the optical anisotropy of the liquid crystal layer so as to change the light transmittance.

However, since liquid crystal display devices as those described above include a liquid crystal display element provided with a pair of polarizing plates, the efficiency of light used for displaying, i.e., the efficiency of light from an illumination device and/or external light is significantly small and it is difficult to improve the light efficiency.

For this reason, an electrowetting display element has been developed among conventional display elements and introduced commercially as described in, for example, Patent document 1. The electrowetting display element displays information by utilizing movements of a conductive droplet caused by an external electric field. That is, this conventional display element includes a pair of transparent support plates, and first and second fluids enclosed between the support plates. The first fluid is colored oil with a predetermined color and the second fluid is a conductive droplet. This conventional display element, each of the first and second fluids alters its shape through the application of an electric field. Thus, the conventional display element has been considered capable of changing the display color on the display surface without using a polarizing plate and capable of improving the light efficiency.

### PRIOR ART DOCUMENT

### Patent Document

Patent Document 1: JP 2007-531917

### DISCLOSURE OF INVENTION

### Problem to be Solved by the Invention

However, in the above-described conventional display element, each pixel needs to be provided with walls to separate one pixel from the other in order to prevent the first and second fluids from leaking into adjacent pixels. For this reason, the conventional display element has a complicated structure and the process for manufacturing the conventional display element therefore is complicated, making a significant increase in cost unavoidable.

With the foregoing in mind, it is an object of the present invention to provide a structurally-simple and low-cost display element that can improve the efficiency of light used for displaying, and to provide an electrical device using the display element.

### Means for Solving Problem

In order to achieve the above object, the display element according to the present invention includes: a first transparent substrate provided on a display surface side; a second transparent substrate provided on a non-display surface side of the first transparent substrate such that a predetermined display space is formed between the first transparent substrate and the second transparent substrate; a first electrode and a second electrode provided on at least one of the first transparent substrate side and the second transparent substrate side; a voltage application portion for applying a voltage to at least one of the first electrode and the second electrode such that an electric field is generated between the first electrode and the second electrode; a soft material enclosed within the display space in an expandable and/or contractable manner, wherein when an electric field is generated between the first electrode and the second electrode the soft material expands and/or contracts in a predetermined direction in response to the generated electric field; and a control portion for receiving an externally input instruction signal and driving the voltage application portion based on the input instruction signal. The control portion causes the soft material to expand and/or contract in the predetermined direction to change a display color on the display surface.

In the display element configured as above, the predetermined display space is formed between the first transparent substrate and the second transparent substrate, and the soft material is enclosed within the display space in an expandable and/or contractable manner. Further, the control portion causes the soft material to expand and/or contract in the predetermined direction to change the display color on the display surface. As a result, it is possible to configure a display element capable of performing display without using a polarizing plate, whereby the efficiency of light used for displaying can be improved. Further, unlike the conventional example described above, there is no need to provide structures such as walls in the display space. Thus, unlike the convention example described above, a structurally-simple and low-cost display element can be configured.

Further, in the display element according to the present invention, a plurality of pixel regions may be provided in a matrix on the display surface side, and in each of the pixel regions, the first electrode may be provided on one of the first transparent substrate side and the second transparent substrate side, and the second electrode is provided on the other of the first transparent substrate side and the second transparent substrate side.

In this case, the soft material expands and/or contracts in response to a vertical electric field generated in a direction perpendicular to the first transparent substrate and the second transparent substrate in each of the pixel regions. Thus, the display color on the display surface can be changed pixel region by pixel region.

Further, in the display element according to the present invention, a plurality of pixel regions may be provided in a matrix on the display surface side, and in each of the pixel regions, the first electrode and the second electrode may be provided on one of the first transparent substrate side and the second transparent substrate side.

In this case, the soft material expands and/or contracts in response to a horizontal electric field generated in a direction parallel to the first transparent substrate and the second transparent substrate in each of the pixel regions. Thus, the display color on the display surface can be changed pixel region by pixel region.

Further, in the display element according to the present invention, it is preferable that a plurality of data lines and a plurality of scanning lines are provided in a matrix on one of the first transparent substrate side and the second transparent substrate side, each of the pixel regions is located at each of intersections of the data lines and the scanning lines, and a switching element connected to the first electrode is provided in each of the pixel regions in the vicinity of each of the intersections of the data lines and the scanning lines, and a data line driving circuit that outputs voltage signals to the data lines in response to instruction signals from the control portion is used as the voltage application portion.

In this case, it is possible to configure a matrix-driven display element having excellent display quality.

Further, in the display element according to the present invention, it is preferable that black matrix layers are provided on at least one of the first transparent substrate side and the second transparent substrate side so as to separate one pixel region from the other of the pixel regions.

In this case, it is possible to make the display color in each of the pixel regions clearer, so that the display quality of the display element can be improved with certainty.

Further, in the display element according to the present invention, it is preferable that a light blocking portion having a predetermined shape is provided in each of the pixel regions, and the display color on the display surface in a corresponding pixel region is changed by causing the soft material to expand and/or contract relative to the light blocking portion.

In this case, the amount of the soft material enclosed within each of the pixel regions can be reduced, so that it is possible to reduce the thickness of the display element and the drive voltage of the soft material.

Further, in the display element according to the present invention, a strip-shaped black matrix provided parallel to a predetermined direction on one of the first transparent substrate side and the second transparent substrate side may be used as the light blocking portion, and a plurality of the soft materials may be provided in each of the pixel regions such that the black matrix is interposed between the soft materials.

In this case, it is possible to change the display color on the display surface in the corresponding pixel region by causing the soft materials to expand and/or contract relative to the strip-shaped black matrix.

Further, in the display element according to the present invention, it is preferable that the soft materials are provided on the same side as the strip-shaped black matrix of the first transparent substrate side and the second transparent substrate side.

In this case, it is possible to improve the display quality of the display element more easily than providing the soft materials on the opposite side to the strip-shaped black matrix.

Further, in the display element according to the present invention, a substantially frame-shaped black matrix may be used as the light blocking portion, the substantially frame-shaped black matrix being provided on one of the first transparent substrate side and the second transparent substrate side so as to have a circular opening having a predetermined radius about the center of a corresponding pixel region, and the display color on the display surface in the pixel region may be changed by causing the soft material to expand and/or contract concentrically about the center of the pixel region relative to the substantially frame-shaped black matrix.

In this case, it is possible to improve the viewing angle characteristics of the display element more so than using the strip-shaped black matrix, so that the display element having excellent display quality can be configured easily.

Further, in the display element according to the present invention, a black-colored soft material provided on one of the first transparent substrate side and the second transparent substrate side may be used as the light blocking portion.

In this case, it is possible to perform white display at higher transmittance than providing a black matrix as the light blocking portion.

Further, in the display element according to the present invention, a black-colored soft material may be used as the soft material.

In this case, the display color on the display surface can be changed between black and white display.

Further, in the display element according to the present invention, it is preferable that an insulating fluid unblendable with the soft material is enclosed within the display space movably.

In this case, it is possible to increase the rate at which the soft material expands and/or contracts easily. Thus, the rate at which the display color on this display surface is changed can also be increased easily.

Further, in the display element according to the present invention, a liquid crystal elastomer having positive dielectric anisotropy may be used as the soft material.

In this case, a normally black or normally white display element can be configured.

Further, in the display element according to the present invention, a liquid crystal elastomer having negative dielectric anisotropy may be used as the soft material.

In this case, a normally black or normally white display element can be configured.

Further, the electrical device according to the present invention is an electrical device comprising a display portion for displaying information including a character and an image. The display element according to the present invention is used as the display portion.

The electrical device configured as above uses, as the display portion, a structurally-simple and low-cost display element that can improve the efficiency of light used for displaying. Thus, it is possible to configure a high-performance and low-cost electrical device with reduced power consumption.

### Effects of the Invention

According to the present invention, it is possible to provide a structurally-simple and low-cost display element that can improve the efficiency of light used for displaying and to provide an electronic device using the display element.

### BRIEF DESCRIPTION OF THE DRAWINGS

FIG. 1 is a cross-sectional view for explaining a display element and a display device according to Embodiment 1 of the present invention.

FIG. 2 is a plan view for explaining a schematic configuration of the display element.

FIG. 3A is a plan view and FIG. 3B is a cross-sectional view of the principal components of the display element.

FIGS. 4A to 4D are drawings for explaining an exemplary operation of the display element, FIG. 4A is a plan view and FIG. 4B is a cross-sectional view of the principal components of the display element in the voltage-off state, and FIG. 4C is a plan view and FIG. 4D is a cross-sectional view of the principal components of the display element in the voltage-on state.

FIGS. 5A and 5B are drawings for explaining specific macroscopic expansion/contraction behavior of the soft materials shown in FIGS. 3A and 3B in the voltage-off state and the voltage-on state, respectively.

FIGS. 6A and 6B are drawings for explaining specific microscopic expansion/contraction behavior of the soft materials in the voltage-off state and the voltage-on state, respectively.

FIG. 7A is a plan view and FIG. 7B is a cross-sectional view of principal components of a display element according to Embodiment 2 of the present invention.

FIGS. 8A to 8D are drawings for explaining an exemplary operation of the display element shown in FIGS. 7A and 7B, FIG. 8A is a plan view and FIG. 8B is a cross-sectional view of the principal components of the display element in the voltage-off state, and FIG. 8C is a plan view and FIG. 8D is a cross-sectional view of the principal components of the display element in the voltage-on state.

FIG. 9A is a plan view and FIG. 9B is a cross-sectional view of principal components of a display element according to Embodiment 3 of the present invention.

FIGS. 10A to 10D are drawings for explaining an exemplary operation of the display element shown in FIGS. 9A and 9B, FIG. 10A is a plan view and FIG. 10B is a cross-sectional view of the principal components of the display element in the voltage-off state, and FIG. 10C is a plan view and FIG. 10D is a cross-sectional view of the principal components of the display element in the voltage-on state.

FIGS. 11A to 11D are drawings for explaining the viewing angle characteristics of the display element shown in FIGS. 3A and 3B.

FIG. 12A is a plan view and FIG. 12B is a cross-sectional view of principal components of a display element according to Embodiment 4 of the present invention.

FIGS. 13A to 13D are drawings for explaining an exemplary operation of the display element shown in FIGS. 12A and 12B, FIG. 13A is a plan view and FIG. 13B is a cross-sectional view of the principal components of the display element in the voltage-off state, and FIG. 13C is a plan view and FIG. 13D is a cross-sectional view of the principal components of the display element in the voltage-on state.

FIG. 14 is a plan view for explaining a schematic configuration of a display element according to Embodiment 5 of the present invention.

FIG. 15A is a plan view and FIG. 15B is a cross-sectional view of the principal components of the display element shown in FIG. 14.

FIGS. 16A to 16D are drawings for explaining an exemplary operation of the display element shown in FIGS. 15A and 15B, FIG. 16A is a plan view and FIG. 16B is a cross-sectional view of the principal components of the display element in the voltage-off state, and FIG. 16C is a plan view and FIG. 16D is a cross-sectional view of the principal components of the display element in the voltage-on state.

FIGS. 17A to 17D are drawings for explaining an exemplary operation of the display element shown in FIGS. 3A and 3B being modified, FIG. 17A is a plan view and FIG. 17B is a cross-sectional view of the principal components of the display element in the voltage-off state, and FIG. 17C is a plan view and FIG. 17D is a cross-sectional view of the principal components of the display element in the voltage-on state.

### DESCRIPTION OF THE INVENTION

Hereinafter, preferred embodiments of the display element and the electrical device of the present invention will be described with reference to the drawings. In the following description, the present invention is applied to a transmission type display device as an example. The size and size ratio of each of the constituent members in each drawing do not exactly reflect those of the actual constituent members.

### Embodiment 1

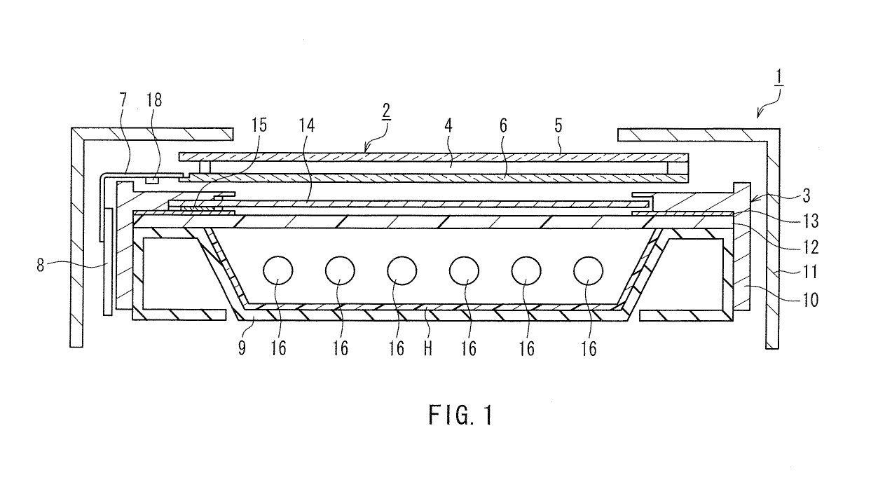

FIG. 1 is a cross-sectional view for explaining a display element and a display device according to Embodiment 1 of the present invention. In the drawing, a display device 1 according to the present embodiment includes a display element 2 of the present invention and an illuminating device 3. The display element 2 as the display portion is placed such that the upper side of the drawing is the viewer side (the display surface side), and the illuminating device 3 is disposed on the non-display surface side (the lower side of the drawing) of the display element 2 and produces illumination light for illuminating the display element 2. As will be described later in detail, the display element 2 is a rectangular display panel provided with a plurality of pixel regions in a matrix on the display surface side. The display element 2 can change the display color on the display surface in each of the pixel regions between white and black by allowing illumination light from the illuminating device 3 to pass therethrough or by blocking the illumination light.

Further, the display element 2 includes a soft material layer 4 containing soft materials (described later) and an upper substrate 5 and a lower substrate 6 between which the soft material layer 4 is interposed. For example, transparent glass substrates are used for the upper substrate 5 and the lower substrate 6, and the upper substrate 5 and the lower substrate 6 serve as a first transparent substrate and a second transparent substrate, respectively. Further, the display element 2 includes a flexible printed circuit board 7 and a printed circuit board 8 connected to the flexible printed circuit board 7. A source driver 18 as a driver for driving the soft material layer 4 pixel by pixel is mounted on the flexible printed circuit board 7. Further, to the printed circuit board 8, a panel control portion (described later) is connected electrically, and the panel control portion drives the source driver 18.

The illuminating device 3 includes a chassis 9 that has a bottom and is open to the upper side of the drawing (i.e., the display element 2 side), and a frame 10 that is provided on the chassis 9 near the display element 2. The chassis 9 and the frame 10 are made of metal or a synthetic resin, and they are supported by a bezel 11 having an L-shaped cross section with the display element 2 being located on the upper side of the frame 10. Specifically, the chassis 9 is the enclosure of the illuminating device 3 and accommodates cold cathode fluorescent tubes (described later) as light sources. The bezel 11 is for accommodating the display element 2. The bezel 11 is attached to the chassis 9 and to the frame 10 with the display element 2 being interposed between the bezel 11 and the frame 10. The illuminating device 3 is attached to the display element 2, and they are integrated into the transmission type display device 1 in which illumination light from the illuminating device 3 enters the display element 2.

The illuminating device 3 further includes a diffusing plate 12 covering the opening of the chassis 9, an optical sheet 14 located above the diffusing plate 12 so as to face the display element 2, and a reflecting sheet H provided on the inner surface of the chassis 9. The illuminating device 3 also includes a plurality of, for example, six cold cathode fluorescent tubes 16 that are provided in the chassis 9 under the display element 2. Thus, the direct type illuminating device 3 is configured. The illuminating device 3 is configured such that light is emitted from each cold cathode fluorescent tube 16 as illumination light through the light emitting surface of the illuminating device 3 opposing the display element 2.

Although the description given above is directed to the case of using the direct type illuminating device 3, the present embodiment is not limited to this configuration. Instead, an edge-light type illuminating device having a light guiding plate may be used. Further, it is also possible to use an illuminating device having light sources other than cold cathode fluorescent tubes, such as hot cathode fluorescent tubes and LEDs.

A rectangular synthetic resin or glass material having a thickness of, for example, about 2 mm is used for the diffusing plate 12. The diffusing plate 12 diffuses light from the cold cathode fluorescent tubes 16 and emits the diffused light toward the optical sheet 14. The four sides of the diffusing plate 12 are placed on the frame-shaped upper surface of the chassis 9. The diffusing plate 12 is incorporated into the illuminating device 3 such that the diffusing plate 12 is sandwiched between the surface of the chassis 9 and the inner surface of the flame 10 via elastically deformable pressing members 13. Moreover, the central portion of the diffusing plate 12 is supported by a transparent supporting member (not shown) provided in the chassis 9, thereby preventing the diffusing plate 12 from being bent inwardly.

The diffusing plate 12 is held movably between the chassis 9 and the pressing members 13. Even if the diffusing plate 12 expands and/or contracts (i.e., plastic deformation) due to the influence of heat, such as heat produced by the cold cathode fluorescent tubes 16 and a rise in temperature inside the chassis 9, the pressing members 13 deform elastically to absorb the plastic deformation, thereby minimizing a decrease in diffusibility of light from the cold cathode fluorescent tubes 16.

The optical sheet 14 includes a condenser sheet made of, for example, a synthetic resin film having a thickness of about 0.5 mm and is configured to increase the brightness of the illumination light emitted to the display element 2. Known optical sheet materials such as a prism sheet may be laminated on top of the optical sheet 14 as needed to improve the display quality of the display element 2 on the display surface. The optical sheet 14 is configured to convert the light emitted from the diffusing plate 12 into planar light having uniform brightness not less than a predetermined value (e.g., 10000 cd/m²) and to allow the planar light to enter the display element 2 as illumination light.

The optical sheet 14 has, at the center of the left end side of FIG. 1, which is to be the upper side in the actual use of the display device 1, protrusions that protrude toward the left side of FIG. 1. Of the optical sheet 14, only the protrusions are interposed between the inner surface of the frame 10 and the pressing members 13 via an elastic material 15. Thus, the optical sheet 14 is incorporated into the illuminating device 3 in an expandable and/or contractable manner. For this reason, even if the optical sheet 14 expands and/or contracts (i.e., plastic deformation) due to the influence of heat such as heat produced by the cold cathode fluorescent tubes 16, the optical sheet 14 can expand and/or contract freely relative to the protrusions, thereby minimizing the chance of the optical sheet 14 becoming wrinkled or bent. As a result, the display device 1 can minimize degradation in the display quality of the display element 2 on the display surface, such as unevenness in brightness, caused by the optical sheet 14 being bent, etc.

Each cold cathode fluorescent tube 16 is of a straight-tube type, and electrode portions (not shown) provided at the both ends are supported outside the chassis 9. Further, each cold cathode fluorescent tube 16 is configured to have a small diameter of about 3.0 to 4.0 mm so as to have excellent light-emission efficiency. Each cold cathode fluorescent tube 16 is held by a light source holder (not shown) within the chassis 9 such that each cold cathode fluorescent tube 16 is kept away from the diffusing plate 12 and the reflecting sheet H at a predetermined distance.

For example, a film having a thickness of about 0.2 to 0.5 mm and made of metal having a high optical reflectance such as aluminum or silver is used for the reflecting sheet H. The reflecting sheet H functions as a reflecting plate that reflects light from the cold cathode fluorescent tubes 16 toward the diffusing plate 12. For this reason, in the illuminating device 3, emitted light from the cold cathode fluorescent tubes 16 can be reflected toward the diffusing plate 12 in an efficient manner, whereby the efficiency of the light and the brightness of the light at the diffusing plate 12 can be improved. In addition to the description given above, a synthetic resin reflecting sheet may be used in place of the metal thin film or a paint such a white paint having a high optical reflectance may be applied onto the inner surface of the chassis 9 to let the inner surface function as a reflecting plate, for example.

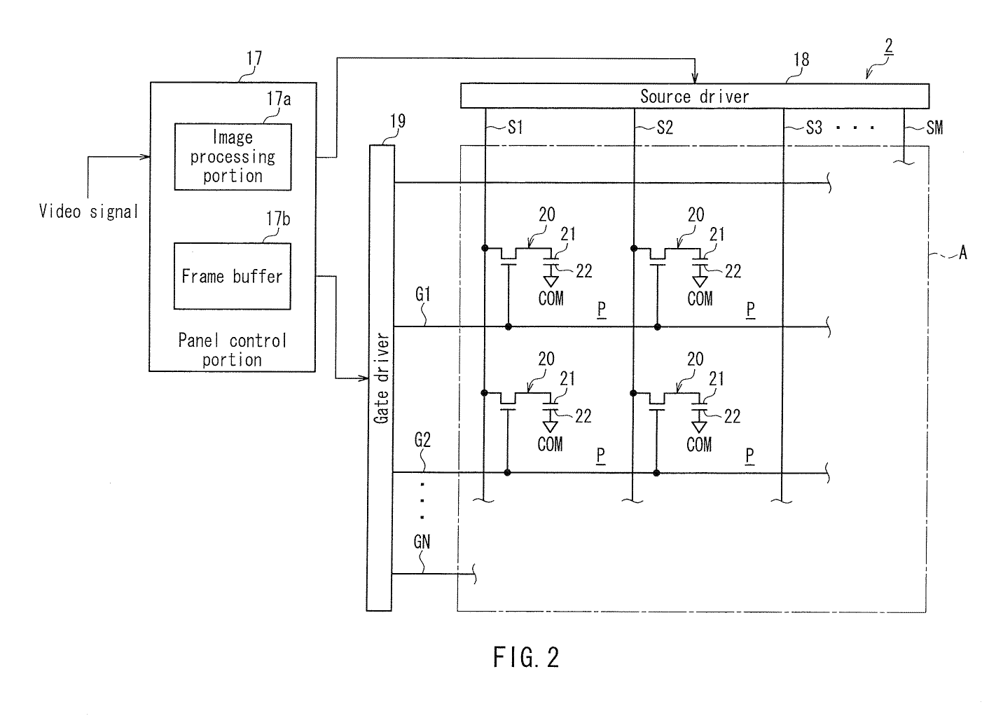

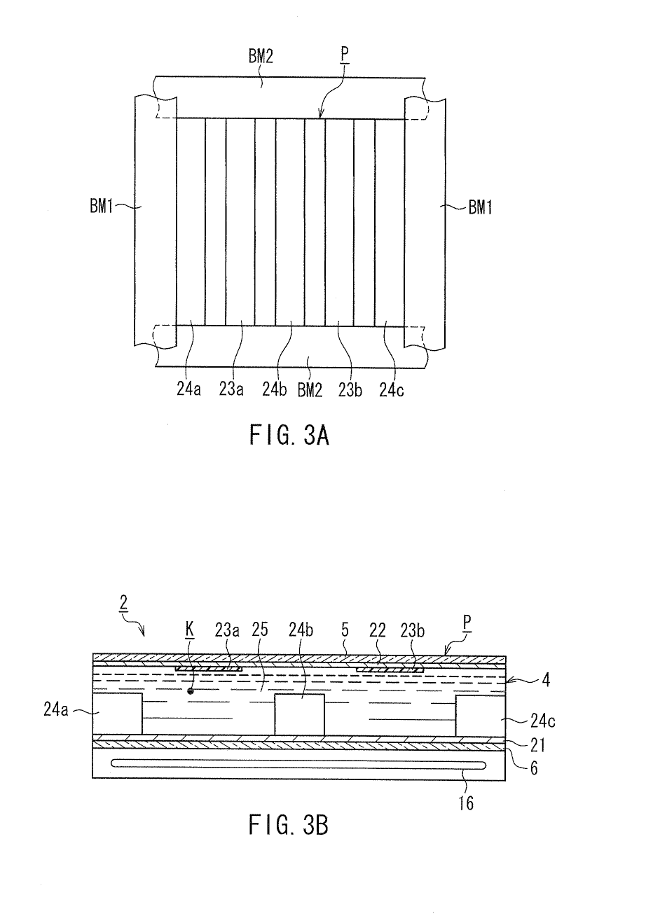

Next, the display element 2 according to the present embodiment will be described specifically also with reference to FIGS. 2 and 3.

FIG. 2 is a plan view for explaining a schematic configuration of the display element. FIG. 3A is a plan view and FIG. 3B is a cross-sectional view of the principal components of the display element.

First, an overall configuration of the display element 2 according to the present embodiment will be described specifically with reference to FIG. 2.

In FIG. 2, a panel control portion 17 serves as a control portion that receives an externally input instruction signal and drives the source driver 18 as a voltage application portion based on the input instruction signal. That is, a video signal (instruction signal) is input to the panel control portion 17 from outside the display device 1. Further, the panel control portion 17 includes an image processing portion 17a for subjecting the input video signal to predetermined image processing to generate instruction signals to the source driver 18 and to a gate driver 19, respectively, and a frame buffer 17b capable of storing one frame of display data contained in the input video signal. The panel control portion 17 drives the source driver 18 and the gate driver 19 in response to the input video signal, so that information according to the video signal is displayed on the display element 2.

As described above, the source driver 18 is mounted on the flexible printed circuit board 7 and serves as the voltage application portion that applies voltages to pixel electrodes (first electrode) described later. Similarly, the gate driver 19 is mounted on a flexible printed circuit board (not shown). The source driver 18 and the gate driver 19 are driving circuits that drive a plurality of pixel regions P provided within the effective display area (display surface) A of the display element 2 pixel by pixel. A plurality of source lines S1 to SM (M is an integer equal to or greater than 2; hereinafter, collectively denoted by “S”) are connected to the source driver 18 and a plurality of gate lines G1 to GN (N is an integer equal to or greater than 2; hereinafter, collectively denoted by “G”) are connected to the gate driver 19.

The source lines S and the gate lines G serve as data lines and scanning lines, respectively. The source lines S and the gate lines G are arranged in a matrix at least within the effective display area A, and each of the pixel regions P is formed in each of the areas divided in a matrix. That is, each of the pixel regions P is located at each of the intersections of the source lines S and the gate lines G in the display element 2. In the display element 2, a thin film transistor (TFT) 20 as a switching element is provided in each of the pixel regions P in the vicinity of each of the intersections of the source lines S and the gate lines G.

Specifically, to each gate line G, the gate of the corresponding thin film transistor 20 is connected. On the other hand, to each source line S, the source of the corresponding thin film transistor 20 is connected. To the drain of each thin film transistor 20, the pixel electrode 21 as the first electrode provided in each pixel is connected. Further, in each pixel, a counter electrode 22 as a second electrode is disposed so as to oppose the pixel electrode 21 via the soft material layer 4 (described later in detail). On the basis of instruction signals from the image processing portion 17a, the gate driver 19 successively outputs to the gate lines G gate signals for turning on the gate of the corresponding thin film transistors 20. On the other hand, the source driver 18 is configured to serve as a data line driving circuit that outputs voltage signals to the source lines S in response to instruction signals from the panel control portion 17. In other words, the source driver 18 outputs, based on instruction signals from the image processing portion 17a, voltage signals (gradation voltage) according to the brightness (gradation) of a display image to the corresponding source lines S.

Although the description give above is directed to the case of using the thin film transistors 20 as switching elements, switching elements that can be used in the present invention are not limited to thin film transistors. For example, other three-terminal switching elements such as a field effect transistor or two-terminal switching elements such as a thin film diode can also be used.

Next, a specific configuration of each of the pixel regions P in the display element 2 according to the present embodiment will be described with reference to FIGS. 3A and 3B.

As shown in FIG. 3A, in each of the pixel regions P of the display element 2, black matrix layers BM1 and BM2 are provided such that the pixel region P is surrounded by the black matrix layers BM1 and BM2. These black matrix layers BM1 and BM2 are provided on at least one of the upper substrate 5 side and the lower substrate 6 side (i.e., the first transparent substrate side and the second transparent substrate side), for example, on the upper substrate 5 side in a matrix so as to separate one pixel region P from the other of the pixel regions P. Further, the black matrix layers BM1 and BM2 are provided above the source line S and the gate line G, respectively, thereby shielding the source line S and the gate line G against light.

Further, as shown in FIG. 3A, in each of the pixel regions P of the display element 2, a plurality of, for example, two strip-shaped black matrices 23a and 23b formed parallel to the black matrix layer BM1 and a plurality of, for example, three soft materials 24a, 24b and 24c (hereinafter collectively denoted by “24”) placed parallel to the black matrix layer BM1 are provided. Furthermore, in each of the pixel regions P, the soft materials 24a and 24b are provided such that the black matrix 23a is interposed therebetween, and the soft materials 24b and 24c are provided such that the black matrix 23b is interposed therebetween.

Further, as shown in FIG. 3B, in the display element 2, a predetermined display space K is formed between the upper substrate (first transparent substrate) 5 and the lower substrate (second transparent substrate) 6, which are provided on the display surface side and the non-display surface side, respectively. The soft materials 24 and colorless transparent ink 25 contained in the soft material layer 4 are enclosed within the display space K. That is, in the display element 2, each of the pixel regions P is defined by an area partitioned by two adjacent source lines S and two adjacent gate lines G, and the soft materials 24 are enclosed within the display area K in an expandable and/or contractable manner in a predetermined direction (i.e., the horizontal direction of FIG. 3) in each of the pixel regions P.

Further, as shown in FIG. 3B, the counter electrode (second electrode) 22 is provided on the surface of the upper substrate 5 facing the display space K. Furthermore, on the upper substrate 5 side, the black matrices 23a and 23b as light blocking portions are provided on the surface of the counter electrode 22. On the other hand, the pixel electrode (the first electrode) 21 is provided on the surface of the lower substrate 6 facing the display space K. The soft materials 24a, 24b and 24c are provided on the surface of the pixel electrode 21. Transparent electrodes such as an ITO film are used for the pixel electrode 21 and the counter electrode 22. Further, the pixel electrode 21 is connected to the source line S (FIG. 2) via the thin film transistor 20. A voltage is applied to the pixel electrode 21 from the source driver 18 to generate an electric field (vertical electric field) between the pixel electrode 21 and the counter electrode 22 in the vertical direction (i.e., the direction perpendicular to the upper substrate 5 and the lower substrate 6).

A negative-type liquid crystal elastomer having negative dielectric anisotropy is used for the soft materials 24. In response to an electric field generated between the pixel electrode 21 and the counter electrode 22, the soft materials 24 expand and/or contract in a direction parallel to the upper substrate 5 and the lower substrate 6 (i.e., the horizontal direction of FIG. 3B) from the initial state as shown in FIG. 3B (described later in detail).

For example, a black pigment or dye is added to the soft materials 24, so that the soft materials 24 are black-colored. In each of the pixel regions P of the display element 2, the soft materials 24a and 24b expand and/or contract below the black matrix 23a and the soft materials 24b and 24c expand and/or contract below the black matrix 23b to block light from the cold cathode fluorescence tubes 16, whereby black display is performed in the pixel region P (described later in detail).

Further, for the transparent ink 25, nonpolar (nonconductive) oil including one or more components selected from side-chain higher alcohols, side-chain higher fatty acids, alkane hydrocarbons, silicone oils, matching oils and the like is used. Further, the transparent ink 25 moves within the display space K as the soft materials 24 expand and/or contract. Further, as shown in FIG. 3A, in the display element 2 according to the present embodiment, the black matrices 23a and 23b and the soft materials 24a to 24c are disposed at predetermined intervals when viewed from the display surface side (i.e., the upper substrate 5 side) when no electric filed is generated between the pixel electrode 21 and the counter electrode 22, so that light from the cold cathode fluorescence tubes 16 can pass therethrough. That is, the display element 2 according to the present embodiment is a so-called normally white display element that performs white display in the voltage-off state.

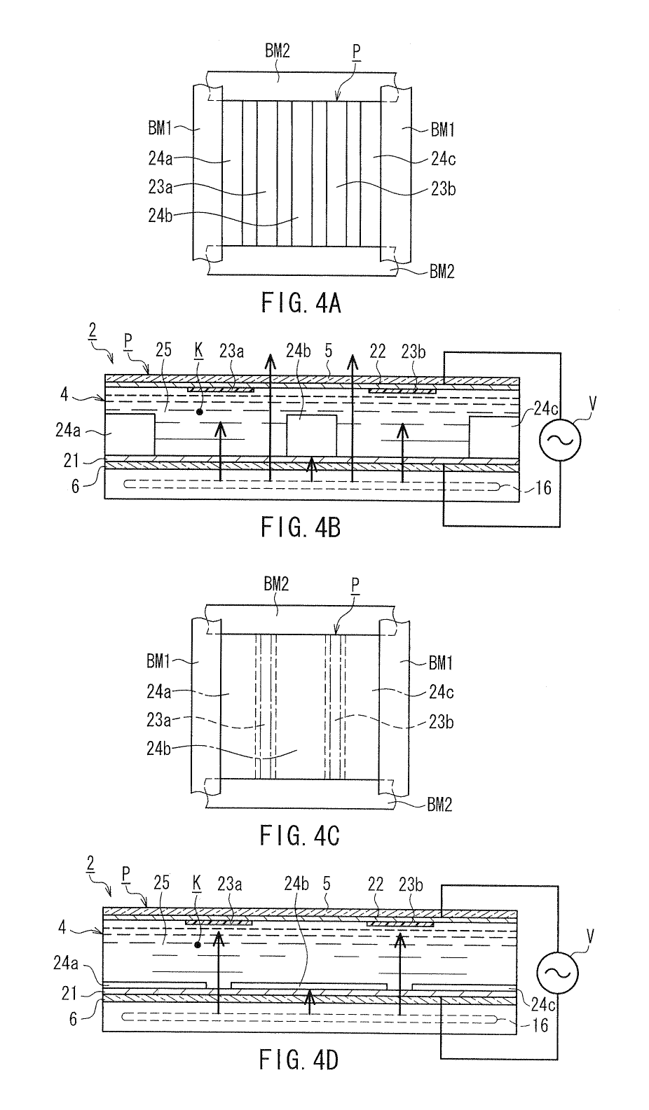

Now, the operation of the display element 2 according to the present embodiment will be described specifically also with reference to FIGS. 4 to 6.

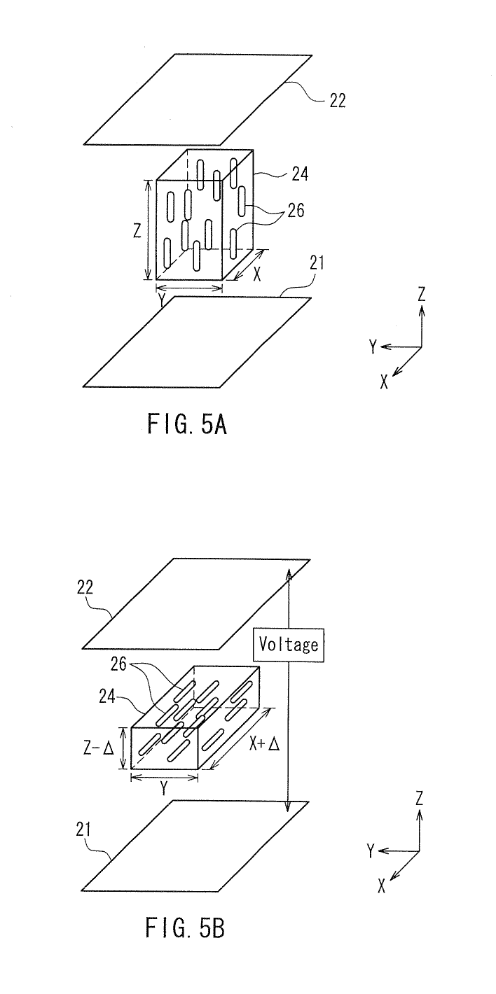

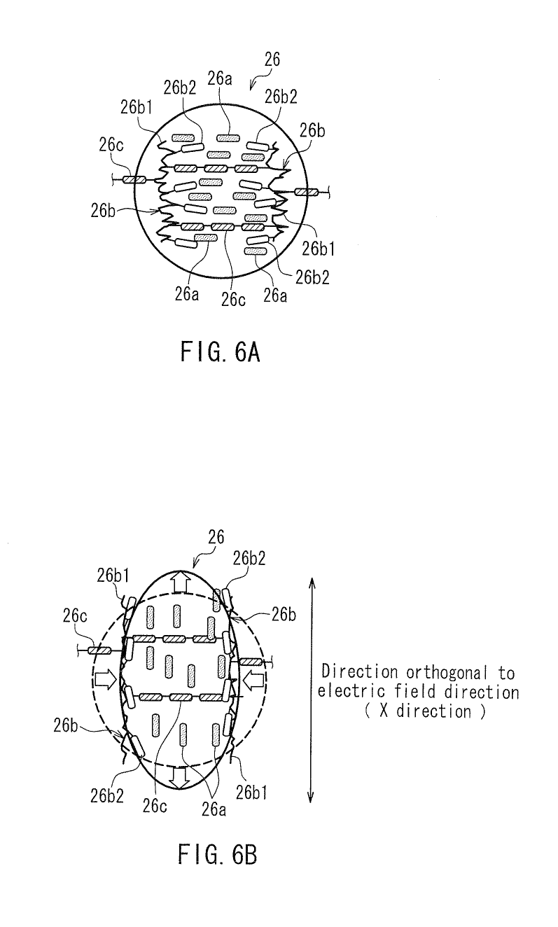

FIGS. 4A to 4D are drawings for explaining an exemplary operation of the display element. FIG. 4A is a plan view and FIG. 4B is a cross-sectional view of the principal components of the display element in the voltage-off state, and FIG. 4C is a plan view and FIG. 4D is a cross-sectional view of the principal components of the display element in the voltage-on state. FIGS. 5A and 5B are drawings for explaining specific macroscopic expansion/contraction behavior of the soft materials shown in FIG. 3 in the voltage-off state and the voltage-on state, respectively. FIGS. 6A and 6B are drawings for explaining specific microscopic expansion/contraction behavior of the soft materials in the voltage-off state and the voltage-on state, respectively.

First, a specific exemplary operation of the display element 2 according to the present embodiment in each of the pixel regions P will be described with reference to FIGS. 4A to 4D.

As shown in FIGS. 4A and 4B, in the display element 2 according to the present embodiment, the soft materials 24 do not expand and/or contract from the state as initially enclosed within the display space K and are retained in the initial shape in the voltage-off state, that is, when no voltage is applied to the pixel electrode 21 from a power source V provided within the source driver 18 and substantially serving as the voltage application portion. Consequently, as shown in FIGS. 4A and 4B, in the display element 2 according to the present embodiment, the soft materials 24a to 24c are retained such that the black matrices 23a and 23b and the soft materials 24a to 24c are disposed at predetermined intervals when viewed from the display surface side (i.e., the upper substrate 5 side). As a result, in the display element 2 according to the present embodiment, illumination light from the cold cathode fluorescent tubes 16 passes through the lower substrate 6, the pixel electrode 21, the transparent ink 25, the counter electrode 22 and the upper substrate 5 in order and is output externally as indicated by the arrows in FIG. 4B as an example. At this time, in the display element 2 according to the present embodiment, the clearance between the two soft materials 24a and 24b adjacent to the black matrix 23a and the clearance between the two soft materials 24b and 24c adjacent to the black matrix 23b become the largest, so that the display color on the display surface becomes completely white.

Further, when the power source V applies to the pixel electrode 21 the maximum voltage responsive to the gradation of a video signal as shown in FIGS. 4C and 4D, an electric field is generated between the pixel electrode 21 and the counter electrode 22 in response to the maximum applied voltage. Consequently, as shown in FIGS. 4C and 4D, in response to the generated electric field the soft materials 24 expand and/or contract on the pixel electrode 21 in the direction parallel to the lower substrate 6. That is, as shown in FIGS. 4C and 4D, the soft material 24a alters its shape from square as shown in FIG. 4B to narrow rectangular as shown in FIG. 4D such that its right end portion is positioned below the black matrix 23a. Further, as shown in FIGS. 4C and 4D, the soft material 24b alters its shape from square as shown in FIG. 4B to narrow rectangular as shown in FIG. 4D such that its right end portion is positioned below the black matrix 23a and its left end portion is positioned below the black matrix 23b. Further, as shown in FIGS. 4C and 4D, the soft material 24c alters its shape from square as shown in FIG. 4B to narrow rectangular as shown in FIG. 4D such that its left end portion is positioned below the black matrix 23b. As a result, in the display element 2 according to the present embodiment, illumination light from the cold cathode fluorescent tubes 16 is blocked by the black matrices 23a and 23b and the soft material 24b as indicated by the arrows in FIG. 4D as an example, so that the display color on the display surface becomes completely black. The maximum voltage applied to the pixel electrode 21 from the power source V is specifically an alternating voltage of few volts to a few tens of volts.

Although the description given above is directed to the case where the power supply V provided in the source driver 18 applies an alternating voltage to the pixel electrode 21, the display element 2 according to the present embodiment is not limited to such a configuration as long as an electric field can be generated between the pixel electrode (first electrode) 21 and the counter electrode (second electrode) 22. So, the display element 2 may be configured to apply voltages to both the pixel electrode 21 and the counter electrode 22 as needed.

Further, the display element 2 according to the present embodiment is can perform grayscale display in an intermediate display color between white and black (i.e., gray) by applying an intermediate voltage between those applied in the voltage-off state and the voltage-on state (the same applies to each of the following embodiments).

Next, specific macroscopic and microscopic expansion/contraction behaviors of the soft materials 24 will be described specifically also with reference to FIGS. 5 and 6.

In FIGS. 5A and 5B, the pixel electrode (first electrode) 21 and the counter electrode (second electrode) 22 in the display element 2 according to the present embodiment are disposed so as to oppose each other to allow generation of the vertical electric field (i.e., an electric field parallel to the Z direction of the drawings). And in the display element 2 according to the present embodiment, the soft materials 24 made of a negative-type liquid crystal elastomer 26 are enclosed between the pixel electrode 21 and the counter electrode 22.

Specifically, in the voltage-off state shown in FIG. 5A, the liquid crystal elastomer 26 as the soft material 24 is oriented vertically through, for example, a vertically oriented film (not shown) so as to be parallel to the Z direction. When a voltage is applied, the liquid crystal elastomer 26 as the soft material 24 expands in the X direction as the direction orthogonal to the electric field direction as shown in FIG. 5B. That is, as shown in FIG. 5B, the soft material 24 expands and/or contracts in such a manner that its dimension in the X direction (i.e., the dimension in the horizontal direction of FIG. 4D) increases by Δ and its dimension in the Z direction (i.e., the dimension in the vertical direction of FIG. 4D) decreases by Δ relative to the dimensions of the soft material 24 in the voltage-off state. Further, the liquid crystal elastomer 26 does not change in its volume between the voltage-off state and the voltage-on state. Moreover, the liquid crystal elastomer 26 does not alter its shape in the Y direction (i.e., the direction perpendicular to the sheet of FIG. 4D) because the Y direction does not involve in the reorientation caused by the electric field.

To be more specific, as shown in FIGS. 6A and 6B, the liquid crystal elastomer 26 includes a low molecular liquid crystal 26a (dotted in the drawings), photopolymerizable liquid crystal monomers 26b each having a liquid crystal main chain 26b1 and liquid crystal side chains 26b2, and a crosslinker 26c (hatched in the drawings) for connecting the photopolymerizable liquid crystal monomers 26b to each other. The liquid crystal elastomer 26 is obtained by swelling the photopolymerizable liquid crystal monomers 26b with the low molecular liquid crystal 26a. Specific examples of materials used for the low molecular liquid crystal 26a include 6OCB (4′-(pentyloxy)-4-biphenylcarbonitrile) and 5CB (4′-pentyl-4-biphenylcarbonitrile). Specific examples of materials used for the photopolymerizable liquid crystal monomers 26b include 6-4-(4-Cyanophenyl) phenoxyl methacrylate. Furthermore, specific examples of materials used for the crosslinker 26c include 1,6-hexanediol diacrylate.

In the voltage-off state shown in FIG. 6A, the low molecular liquid crystal 26a and the liquid crystal side chains 26b2 in the liquid crystal elastomer 26 are oriented so as to be parallel to the Z direction (i.e., the orientation direction). On the other hand, in the voltage-on state shown in FIG. 6B, the low molecular liquid crystal 26a and the liquid crystal side chains 26b2 in the liquid crystal elastomer 26 are reoriented in the direction orthogonal to the electric field direction (i.e., the X direction) and the liquid crystal main chain 26b1 expands and/or contracts along the X direction. As a result, the liquid crystal elastomer 26 as the soft material 24 expands in the X direction (i.e., the direction orthogonal to the electric field direction) in the voltage-on state as shown in FIG. 5B, and partially overlaps with the black matrices 23a and 23b in the Z direction.

Further, a photopolymerimerizable liquid crystal pigment is introduced into the liquid crystal main chain 26b1 and the liquid crystal side chains 26b2 in the liquid crystal elastomer 26 to color the soft material 24 black. Examples of photopolymerizable liquid crystal pigments include pigment materials used for application-type polarizing plates and GH mode liquid crystals and photopolymerizable functional groups such as acrylate, methacrylate, acrylamide, methacrylamide, vinyl, vinyloxy and epoxy groups.

In the display element 2 according to the present embodiment configured as above, the predetermined display space K is formed between the upper substrate (first transparent substrate) 5 and the lower substrate (second transparent substrate) 6, and the soft materials 24 are enclosed within the display space K in an expandable and/or contractable manner. Further, in the display element 2 according to the present embodiment, the panel control portion (control portion) 17 causes the soft materials 24 to expand and/or contract in a predetermined direction in response to an external video signal so as to change the display color on the display surface. As a result, in the present embodiment, it is possible to configure the display element 2 that can perform display without using a polarizing plate, so that the efficiency of light used for displaying can be improved. Further, unlike the conventional example described above, there is no need to provide structures such as walls in the display space K in the present embodiment. Consequently, it is possible to configure the structurally-simple and low-cost display element 2 in the present embodiment unlike the conventional example described above.

Further, in the display element 2 according to the present embodiment, the pixel regions P are provided in a matrix on the display surface side, the pixel electrode (first electrode) 21 and the counter electrode (second electrode) 22 are provided on the lower substrate 6 and the upper substrate 5, respectively, in each of the pixel regions P. Thus, in the display element 2 according to the present embodiment, the soft materials 24 expand and/or contract in response to the vertical electric field in each of the pixel regions P, so that the display color on the display surface can be changed pixel region P by pixel region P.

Further, in the display element 2 according to the present embodiment, the source lines (data lines) S and the gate lines (scanning lines) G are provided in a matrix on the lower substrate 6 side. Further, each of the pixel regions P is located at each of the intersections of the source lines S and the gate lines G, and the thin film transistor (switching element) 20 connected to the pixel electrode 21 is provided in each of the pixel regions P in the vicinity of each of the intersections of the source lines S and the gate lines G. Furthermore, the source driver (data line driving circuit) 18 that outputs voltage signals to the source lines S in response to instruction signals from the panel control portion 17 is used as the voltage application portion. Consequently, the matrix-driven display element 2 having excellent display quality can be configured in the present embodiment.

Further, in the display element 2 according to the present embodiment, the black matrix layers BM1 and BM2 are provided on the upper substrate 5 side so as to separate one pixel region from the other of the pixel regions P. Consequently, the display element 2 according to the present embodiment can make the display color in each of the pixel regions P clearer, so that the display quality of the display element 2 can be improved with certainty.

Because the display device 1 according to the present embodiment uses, as the display portion, the structurally-simple and low-cost display element 2 that can improve the efficiency of light used for displaying, it is possible to configure the high-performance and low-cost display device (electrical device) 1 with reduced power consumption.

### Embodiment 2

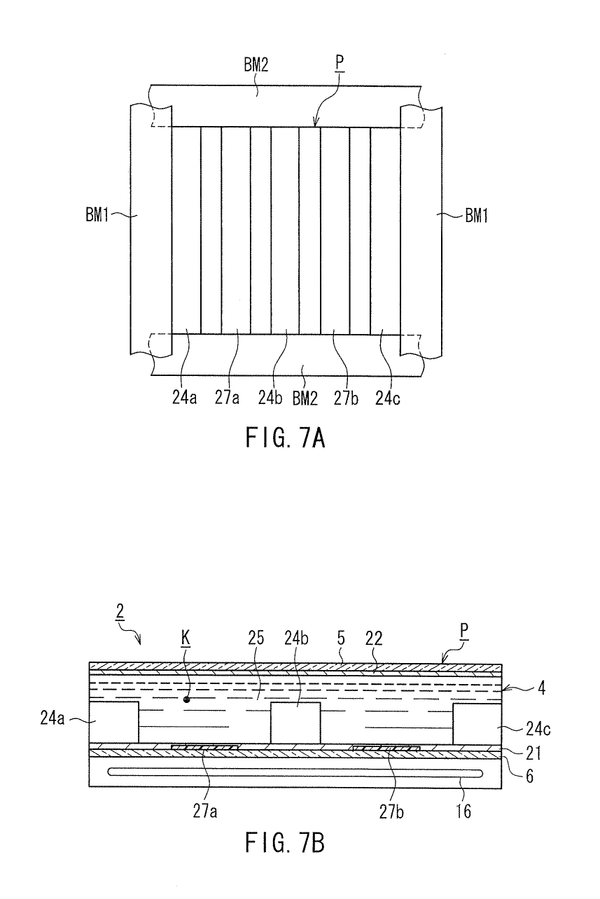

FIG. 7A is a plan view and FIG. 7B is a cross-sectional view of principal components of a display element according to Embodiment 2 of the present invention. In the drawings, the major difference between the present embodiment and Embodiment 1 is that a plurality of soft materials and a plurality of strip-shaped black matrices are provided on the lower substrate (second transparent substrate) side. Note that the same components as in Embodiment 1 are denoted by the same reference numerals and the detailed description thereof will not be repeated.

That is, as shown in FIGS. 7A and 7B, in the display element 2 according to the present embodiment, a plurality of, for example, two strip-shaped black matrices 27a and 27b formed parallel to the black matrix layer BM1 are provided on the lower substrate (second transparent substrate) 6 side, and they are covered with the pixel electrode 21. Specifically, the black matrix 27a is provided so as to be interposed between soft materials 24a and 24b, and the black matrix 27b is provided so as to be interposed between soft materials 24b and 24c. These black matrices 27a and 27b serve as light blocking portions and they contribute to black display in the corresponding pixel region P as in Embodiment 1.

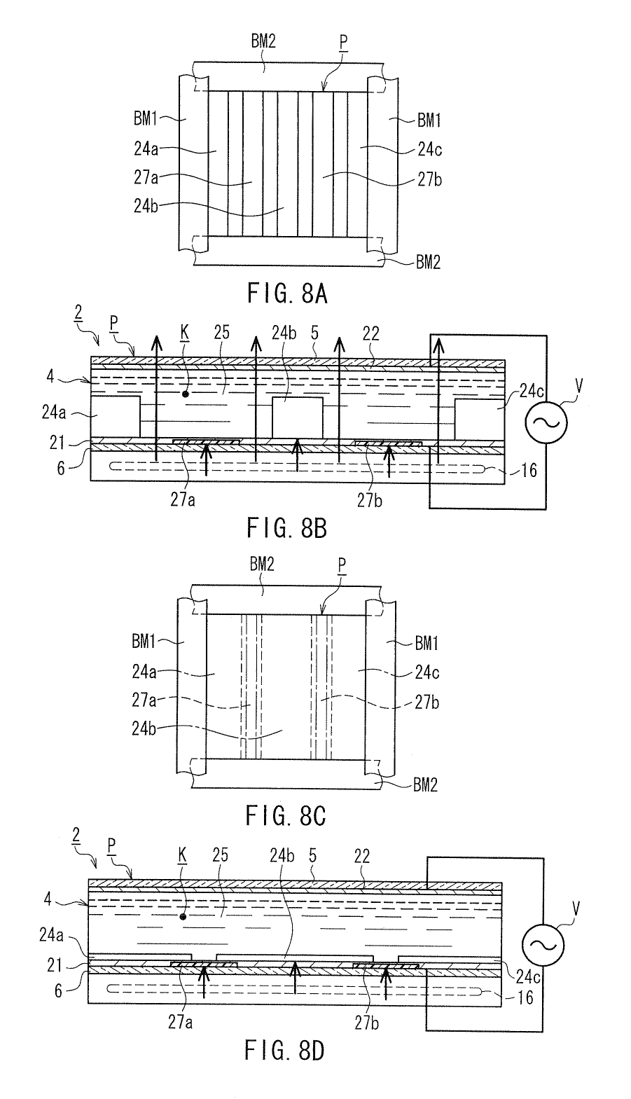

Now, the operation of the display element 2 according to the present embodiment will be described specifically with reference to FIGS. 8A to 8D.

FIGS. 8A to 8D are drawings for explaining an exemplary operation of the display element shown in FIGS. 7A and 7B. FIG. 8A is a plan view and FIG. 8B is a cross-sectional view of the principal components of the display element in the voltage-off state, and FIG. 8C is a plan view and FIG. 8D is a cross-sectional view of the principal components of the display element in the voltage-on state.

As shown in FIGS. 8A and 8B, in the display element 2 according to the present embodiment, the soft materials 24 do not expand and/or contract from the state as initially enclosed within the display space K and are retained in the initial shape in the voltage-off state, that is, when no voltage is applied to the pixel electrode 21 from the power source V provided within the source driver 18 and substantially serving as the voltage application portion. Consequently, as shown in FIGS. 8A and 8B, in the display element 2 according to the present embodiment, the black matrices 27a and 27b and the soft materials 24a to 24c are retained so as to be disposed at predetermined intervals when viewed from the display surface side (the upper substrate 5 side). As a result, in the display element 2 according to the present embodiment, illumination light from the cold cathode fluorescent tubes 16 passes through the lower substrate 6, the pixel electrode 21, the transparent ink 25, the counter electrode 22 and the upper substrate 5 in order and is output externally as indicated by the arrows in FIG. 8B as an example. At this time, in the display element 2 according to the present embodiment, the clearance between the two soft materials 24a and 24b adjacent to the black matrix 27a and the clearance between the two soft materials 24b and 24c adjacent to the black matrix 27b become the largest, so that the display color on the display surface becomes completely white.

Further, when the power source V applies to the pixel electrode 21 the maximum voltage responsive to the gradation of a video signal as shown in FIGS. 8C and 8D, an electric field is generated between the pixel electrode 21 and the counter electrode 22 in response to the maximum applied voltage. Consequently, as shown in FIGS. 8C and 8D, in response to the generated electric field the soft materials 24 expand and/or contract on the pixel electrode 21 in the direction parallel to the lower substrate 6. That is, as shown in FIGS. 8C and 8D, the soft material 24a alters its shape from square as shown in FIG. 8B to narrow rectangular as shown in FIG. 8D such that its right end portion is positioned above the black matrix 27a. Further, as shown in FIGS. 8C and 8D, the soft material 24b alters its shape from square as shown in FIG. 8B to narrow rectangular as shown in FIG. 8D such that its right end portion is positioned above the black matrix 27a and its left end portion is positioned above the black matrix 27b. Further, as shown in FIGS. 8C and 8D, the soft material 24c alters its shape from square as shown in FIG. 8B to narrow rectangular as shown in FIG. 8D such that its left end portion is positioned above the black matrix 27b. As a result, in the display element 2 according to the present embodiment, illumination light from the cold cathode fluorescent tubes 16 is blocked by the black matrices 27a and 27b and the soft material 24b as indicated by the arrows in FIG. 8D as an example, so that the display color on the display surface becomes completely black.

As a result of the configuration described above, the present embodiment can produce the same effects as those of Embodiment 1. Furthermore, the soft materials 24 and the black matrices 27a and 27b are provided on the lower substrate (second transparent substrate) 6 side in the display element 2 according to the present embodiment. Thus, the display quality of the display element 2 can be improved more easily in the present embodiment than in Embodiment 1 where the soft materials 24 are provided on the opposite side to the upper substrate 5 side, where the black matrices 23a and 23b are provided. Specifically, since the soft materials 24 and the black matrices 27a and 27b are provided on the same substrate side (i.e., the lower substrate 6 side), it is possible to reduce the dependence of the viewing angle characteristics and light blocking characteristics of the display element 2 on the cell thickness. That is, it is possible to significantly reduce variations in the viewing angle characteristics and the light blocking characteristics resulting from the variations in the cell thickness between the upper substrate 5 and the lower substrate 6. Moreover, the distance between the soft materials 24 and the black matrices 27a and 27b can be reduced more so than in Embodiment 1 at the time of black display.

Thus, the occurrence of light leakage can be minimized and the display quality at the time of black display can therefore be improved.

### Embodiment 3

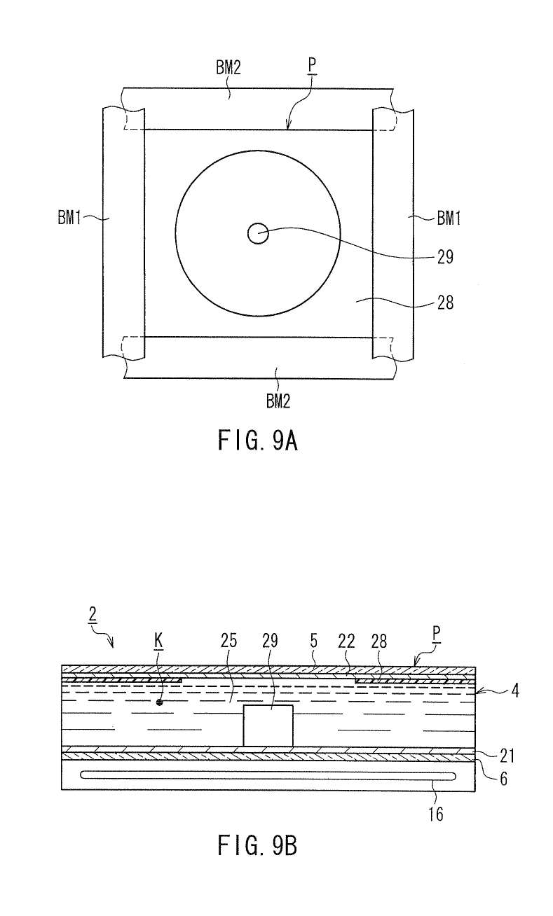

FIG. 9A is a plan view and FIG. 9B is a cross-sectional view of principal components of a display element according to Embodiment 3 of the present invention. In the drawings, the major differences between the present embodiment and Embodiment 1 are as follows: a substantially frame-shaped black matrix is used as a light blocking portion; and a soft material is oriented radially to allow the soft material to expand and/or contract concentrically about the center of the pixel region relative to the substantially frame-shaped black matrix, thereby changing the display color on the display surface in the pixel region. Note that the same components as in Embodiment 1 are denoted by the same reference numerals and the detailed description thereof will not be repeated.

That is, as shown in FIGS. 9A and 9B, in the display element according to the present embodiment, a substantially frame-shaped black matrix 28 is provided, as a light blocking portion, in each of the pixel regions P on the upper substrate 5 side. The black matrix 28 is provided so as to have a circular opening having a predetermined radius about the center of the corresponding pixel region P.

In each of the pixel regions P of the display element 2 according to the present embodiment, the soft material 29 is disposed at the center of the pixel region P and is configured to be expandable and/or contractable concentrically about the center of the pixel region P relative to the substantially frame-shaped black matrix 28. That is, the soft material 29 is oriented radially through a conical orientation film (not shown) provided on the pixel electrode 21, and when an electric field (vertical electric field) is generated between the pixel electrode 21 and the counter electrode 22, the soft material 29 expands and/or contracts concentrically in response to the generated electric field (described later in detail).

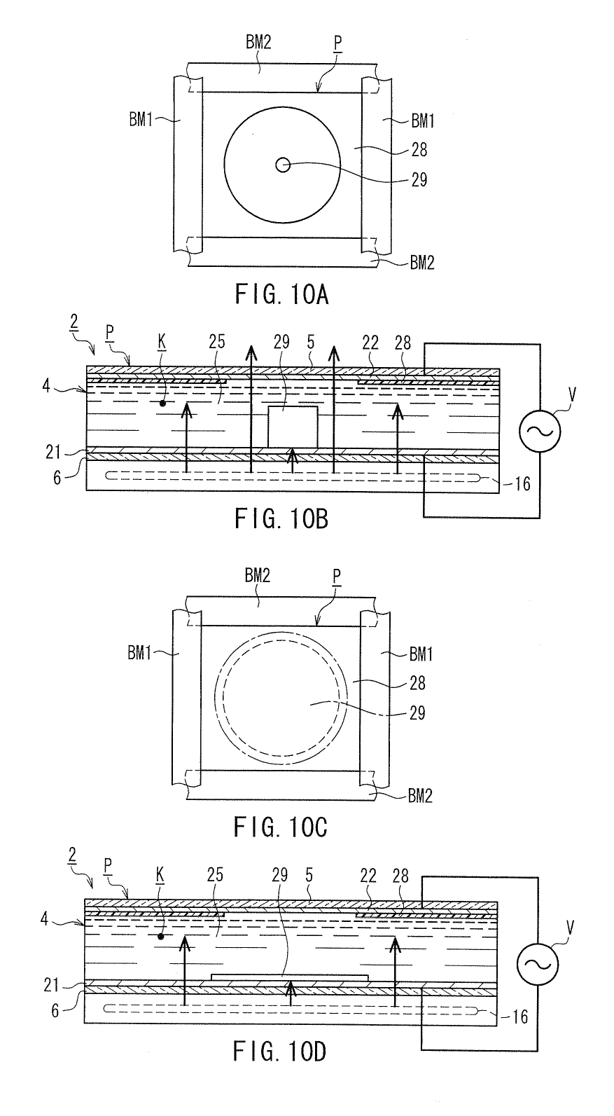

Now, the operation of the display element 2 according to the present embodiment will be described specifically with reference to FIGS. 10A to 10D.

FIGS. 10A to 10D are drawings for explaining an exemplary operation of the display element shown in FIGS. 9A and 9B. FIG. 10A is a plan view and FIG. 10B is a cross-sectional view of the principal components of the display element in the voltage-off state, and FIG. 10C is a plan view and FIG. 10D is a cross-sectional view of the principal components of the display element in the voltage-on state.

As shown in FIGS. 10A and 10B, in the display element 2 according to the present embodiment, the soft material 29 does not expand and/or contract from the state as initially enclosed within the display space K and is retained in the initial shape in the voltage-off state, that is, when no voltage is applied to the pixel electrode 21 from the power source V provided within the source driver 18 and substantially serving as the voltage application portion. Consequently, as shown in FIGS. 10A and 10B, in the display element 2 according to the present embodiment, the black matrix 28 and the soft material 29 are retained so as to be disposed at a predetermined interval when viewed from the display surface side (i.e., the upper substrate 5 side). As a result, in the display element 2 according to the present embodiment, illumination light from the cold cathode fluorescent tubes 16 passes through the lower substrate 6, the pixel electrode 21, the transparent ink 25, the counter electrode 22 and the upper substrate 5 in order and is output externally as indicated by the arrows in FIG. 10B as an example. At this time, in the display element 2 according to the present embodiment, the clearance between the black matrix 28 and the soft material 29 becomes the largest, so that the display color on the display surface becomes completely white.

Further, when the power source V applies to the pixel electrode 21 the maximum voltage responsive to the gradation of a video signal as shown in FIGS. 10C and 10D, an electric field is generated between the pixel electrode 21 and the counter electrode 22 in response to the maximum applied voltage. Consequently, as shown in FIGS. 10C and 10D, in response to the generated electric field the soft material 29 expands and/or contracts on the pixel electrode 21 concentrically. That is, as shown in FIGS. 10C and 10D, the soft material 29 alters its shape from square as shown in FIG. 10B to narrow rectangular as shown in FIG. 10D such that its outer region is positioned below the black matrix 28. That is, the soft material 29 alters its shape from a cylindrical shape to a more flat cylindrical shape (disk shape). As a result, in the display element 2 according to the present embodiment, illumination light from the cold cathode fluorescent tubes 16 is blocked by the black matrix 28 and the soft material 29 as indicated by the arrows in FIG. 10D as an example, so that the display color on the display surface becomes completely black.

As a result of the configuration described above, the present embodiment can produce the same effects as those of Embodiment 1. Furthermore, in the display element 2 according to the present embodiment, the substantially frame-shaped black matrix 28 is used, and the soft material 29 is oriented radially to allow the soft material 29 to expand and/or contract concentrically about the center of the pixel region P relative to the substantially frame-shaped black matrix 28, thereby changing the display color on the display surface in the pixel region P. Consequently, the viewing angle characteristics of the display element 2 can be improved more so than in Embodiment 1 where the strip-shaped black matrices 23a and 23b are used. Thus, it is possible to configure the display element 2 having excellent display quality easily.

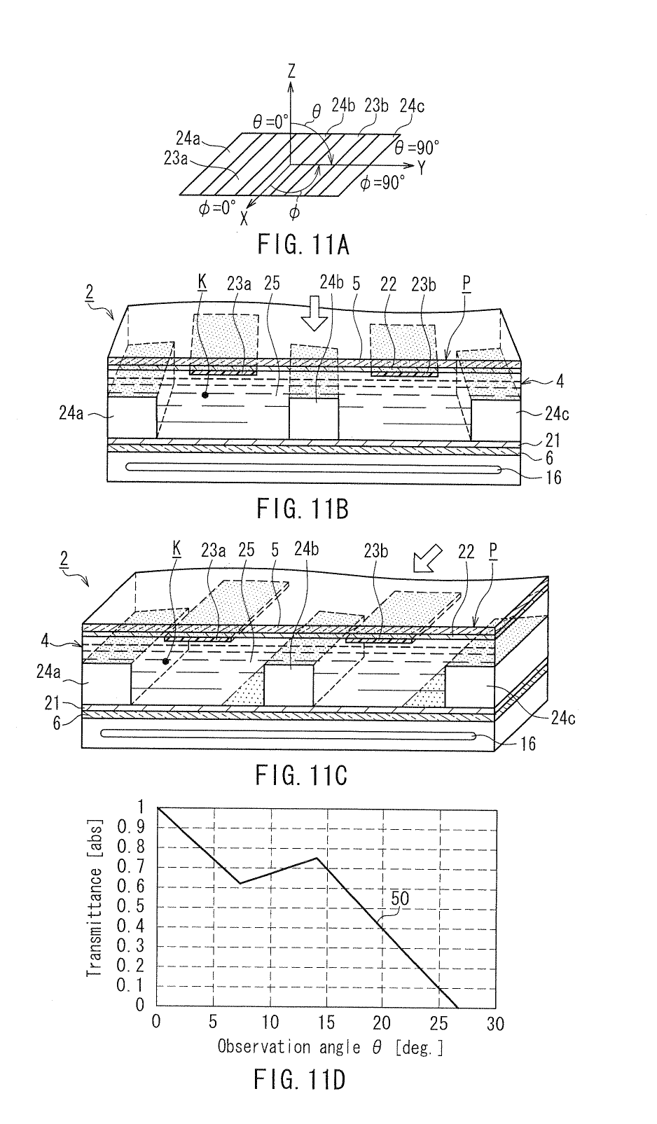

Hereinafter, the viewing angle characteristics of the display element 2 according to Embodiment 1 will be described specifically with reference to FIGS. 11A to 11D.

FIGS. 11A to 11D are drawings for explaining the viewing angle characteristics of the display element shown in FIGS. 3A and 3B.

As shown in FIG. 11A, it is assumed that the pixel region P is defined by the X, Y and Z axes, and the angle of inclination between the Z and Y axes is defined as θ and the angle of inclination between the X and Y axes is defined as cp. At this time, if a user's visual angle is tilted in a direction parallel to the strip-shaped black matrices 23a and 23b, that is, if the angles of inclination (θ, φ) are tilted from (0, 0) to (90, 0), the soft materials 24 do not serve as light blocking objects as they are provided parallel to the black matrices 23a and 23b, so that the transmittance of the pixel region P does not change.

On the other hand, if the user's visual angle is tilted in a direction perpendicular to the black matrices 23a and 23b, that is, if the angles of inclination (θ, φ) are tilted from (0, 0) to (90, 90), light is blocked by the shadows of the soft materials 24, resulting in variations in the transmittance of the pixel region P depending on the visual angle. Specifically, when the user looks at the pixel region P from directly thereabove ((θ, φ)=(90, 0)) as indicated by the white arrow in FIG. 11B, the shadows of the soft materials 24 cannot be visually identified. However, when the user's visual angle is tilted in the direction perpendicular to the black matrices 23a and 23b as indicated by the white arrow in FIG. 11C, for example, when the user looks at the pixel region P at a visual angle of (θ, φ)=(90, 45), the shadow of the soft material 24b develops between the soft material 24b and the black matrix 23a and the shadow of the soft material 24c develops between the soft material 24c and the black matrix 23a, resulting in variations in the transmittance of the pixel region P. More specifically, as a graph 50 in FIG. 11D indicates, the transmittance of the pixel region P varies depending on the observation angle θ.

As described above, in the display element 2 according to Embodiment 1 using the strip-shaped black matrices 23a and 23b, issues concerning viewing angle characteristics arise as the transmittance varies depending on the angle at which the user visually identifies (visual angle).

In contrast, in the present embodiment using the substantially frame-shaped black matrix 28 and the radially oriented soft material 29, the transmittance does not vary depending on the angle at which the user visually identifies. As a result, the viewing angle characteristics of the display element 2 can be improved in the present embodiment, so the display element 2 having excellent display quality can be configured easily.

In addition to the description given above, the substantially frame-shaped black matrix 28 may also be provided on the lower substrate 6 side.

### Embodiment 4

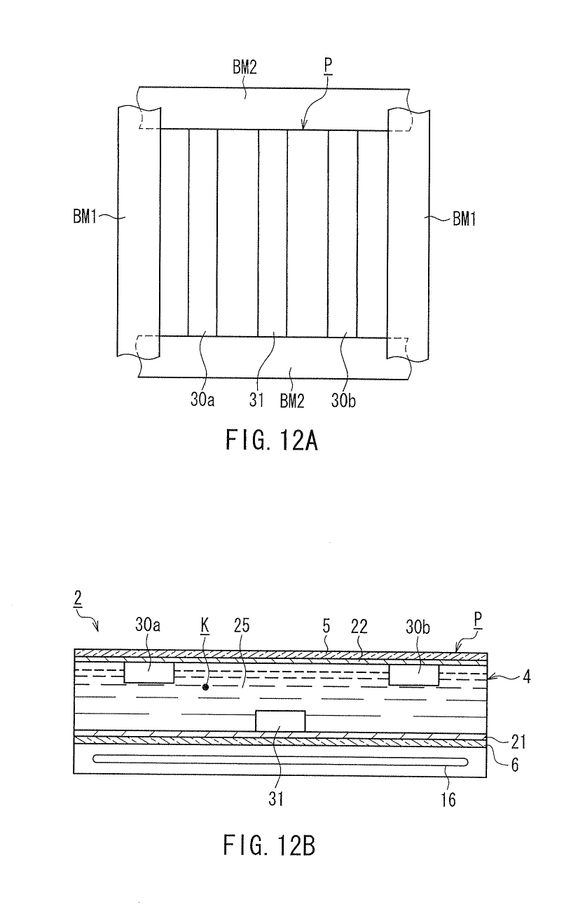

FIG. 12A is a plan view and FIG. 12B is a cross-sectional view of principal components of a display element according to Embodiment 4 of the present invention. In the drawings, the major difference between the present embodiment and Embodiment 1 is that black-colored soft materials are used as light blocking portions. Note that the same components as in Embodiment 1 are denoted by the same reference numerals and the detailed description thereof will not be repeated.

That is, as shown in FIGS. 12A and 12B, in the display element 2 according to the present embodiment, black-colored soft materials 30a and 30b are formed parallel to the black matrix layer BM1 on the upper substrate 5 side. These soft materials 30a and 30b serve as light blocking portions and contribute to black display in the corresponding pixel region P as in Embodiment 1.

Further, in the display element 2 according to the present embodiment, a soft material 31 is provided on the lower substrate 6 side so as to be interposed between the soft materials 30a and 30b. Note that substantially the same material is used for the soft materials 30a, 30b and 31.

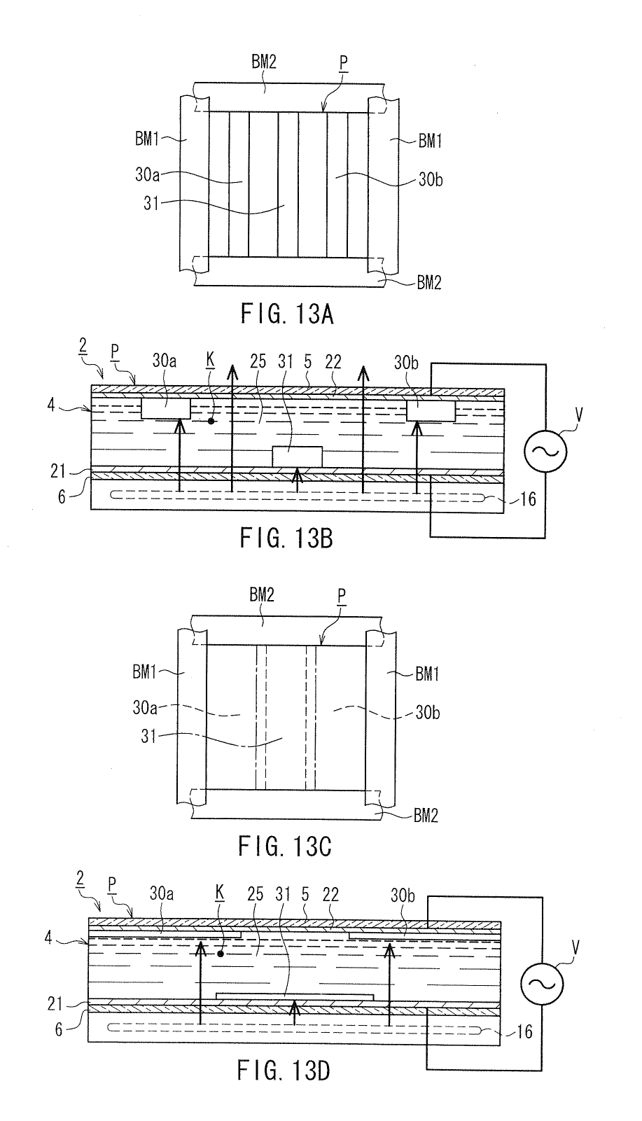

Now, the operation of the display element 2 according to the present embodiment will be described specifically with reference to FIGS. 13A to 13D.

FIGS. 13A to 13D are drawings for explaining an exemplary operation of the display element shown in FIGS. 12A and 12B. FIG. 13A is a plan view and FIG. 13B is a cross-sectional view of the principal components of the display element in the voltage-off state, and FIG. 13C is a plan view and FIG. 13D is a cross-sectional view of the principal components of the display element in the voltage-on state.

As shown in FIGS. 13A and 13B, in the display element 2 according to the present embodiment, the soft materials 30a, 30b and 31 do not expand and/or contract from the state as initially enclosed within the display space K and are retained in the initial shape in the voltage-off state, that is, when no voltage is applied to the pixel electrode 21 from the power source V provided within the source driver 18 and substantially serving as the voltage application portion. Consequently, as shown in FIGS. 13A and 13B, in the display element 2 according to the present embodiment, the soft materials 30a, 30b and 31 are retained so as to be disposed at predetermined intervals when viewed from the display surface side (i.e., the upper substrate 5 side). As a result, in the display element 2 according to the present embodiment, illumination light from the cold cathode fluorescent tubes 16 passes through the lower substrate 6, the pixel electrode 21, the transparent ink 25, the counter electrode 22 and the upper substrate 5 in order and is output externally as indicated by the arrows in FIG. 13B as an example. At this time, in the display element 2 according to the present embodiment, the clearance between the soft materials 30a and 31 and the clearance between the soft materials 30b and 31 become the largest, so that the display color on the display surface becomes completely white.

Further, when the power source V applies to the pixel electrode 21 the maximum voltage responsive to the gradation of a video signal as shown in FIGS. 13C and 13D, an electric field is generated between the pixel electrode 21 and the counter electrode 22 in response to the maximum applied voltage. Consequently, as shown in FIGS. 13C and 13D, in response to the generated electric field the soft materials 30a and 30b expand and/or contract above the pixel electrode 21 and the soft material 31 expands and/or contract on the pixel electrode 21 in the direction parallel to the lower substrate 6. That is, as shown in FIGS. 13C and 13D, the soft material 30a alters its shape from square as shown in FIG. 13B to narrow rectangular as shown in FIG. 13D such that its right end portion is positioned above the left end portion of the soft material 31. Further, as shown in FIGS. 13C and 13D, the soft material 31 alters its shape from square as shown in FIG. 13B to narrow rectangular as shown in FIG. 13D such that its right end portion is positioned below the soft material 30a and its left end portion is positioned below the soft material 30b. Further, as shown in FIGS. 13C and 13D, the soft material 30b alters its shape from square as shown in FIG. 13C to narrow rectangular as shown in FIG. 13D such that its left end portion is positioned above the right end portion of the soft material 31. As a result, in the display element 2 according to the present embodiment, illumination light from the cold cathode fluorescent tubes 16 is blocked by the soft materials 30a, 30b and 31 as indicated by the arrows in FIG. 13D as an example, so that the display color on the display surface becomes completely black.

As a result of the configuration described above, the present embodiment can produce the same effects as those of Embodiment 1. Further, in the display element 2 according to the present embodiment, the black-colored soft materials 30a and 30b are provided on the upper substrate (first transparent substrate) 5 side as light blocking portions. Consequently, in the display element 2 according to the present embodiment, the numerical aperture of each of the pixel regions P at the time of white display can be increased more so then in Embodiment 1, so that white display can be performed at a high transmittance.

### Embodiment 5

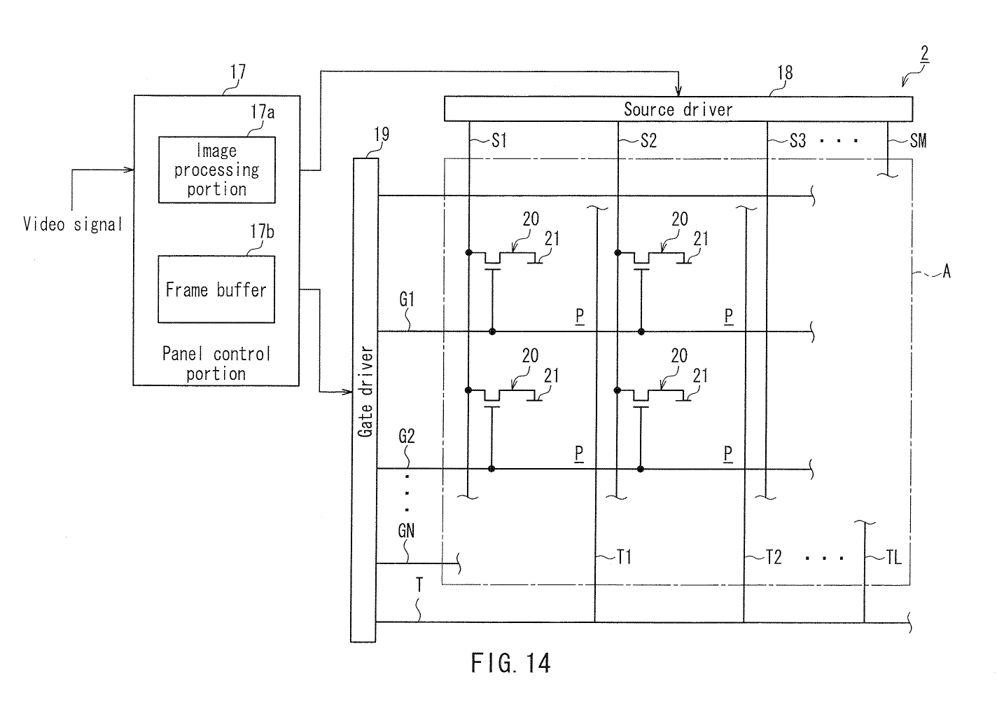

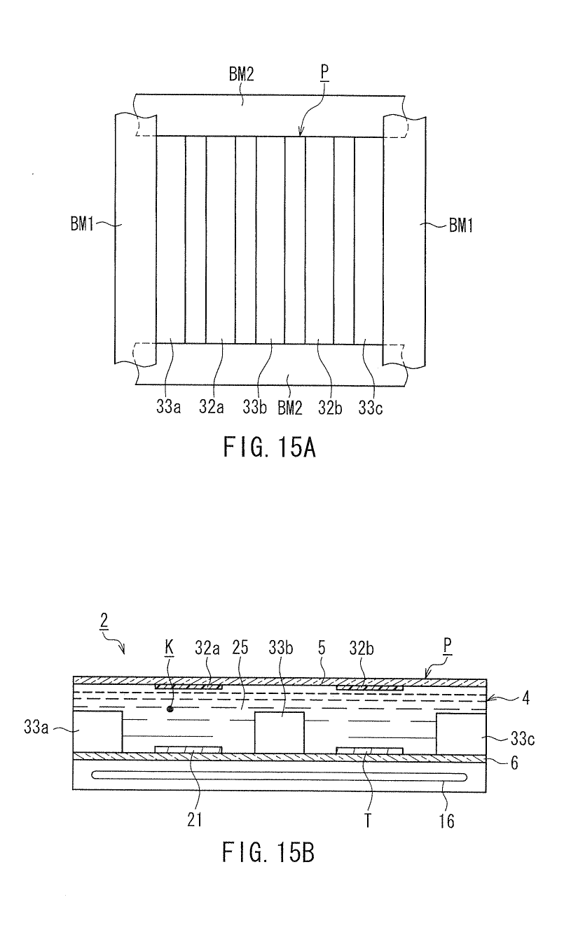

FIG. 14 is a plan view for explaining a schematic configuration of a display element according to Embodiment 5 of the present invention. FIG. 15A is a plan view and FIG. 15B is a cross-sectional view of the principal components of the display element shown in FIG. 14. In the drawings, the major difference between the present embodiment and Embodiment 1 is that common electrodes are provided on the lower substrate side as the second electrodes in place of the counter electrode so as to generate a horizontal electric field between each pixel electrode and each common electrode. Note that the same components as in Embodiment 1 are denoted by the same reference numerals and the detailed description thereof will not be repeated.

That is, as shown in FIG. 14, the display element 2 according to the present embodiment is provided with a plurality of common electrodes T1 to TL (L is an integer equal to or greater than 2; hereinafter, collectively denoted by “T”). Each of the common electrodes T is connected to the gate driver 19 and is provided in each of the pixel regions P so as to be parallel to the source lines S.

Further, the common electrodes T serve as the second electrodes and each of the common electrodes T is formed on the lower substrate 6 (FIG. 15B) in each of the pixel regions P so as to be parallel to the pixel electrode 21, as shown in FIG. 14. The display element 2 according to the present embodiment is configured such that when a voltage responsive to a video signal is applied to each pixel electrode 21 from the source driver 18, an electric field (horizontal electric field) is generated between the pixel electrode 21 and the common electrode T in the horizontal direction (i.e., the direction parallel to the upper substrate 5 and the lower substrate 6).

Further, as shown in FIGS. 15A and 15B, in each of the pixel regions P of the display element 2 according to the present embodiment, a plurality of, for example, two strip-shaped black matrices 32a and 32b formed parallel to the black matrix layer BM1 are formed on the surface of the upper substrate 5. Further, in each of the pixel regions P, a plurality of, for example, three soft materials 33a, 33b and 33c (hereinafter collectively denoted by “33”) are provided parallel to the black matrix layer BM1. Further, in each of the pixel regions P, the soft materials 33a and 33b are provided such that the black matrix 32a is interposed therebetween, and the soft materials 33b and 33c are provided such that the black matrix 32b is interposed therebetween.

In the display element 2 according to the present embodiment, the pixel electrode 21 and the common electrode T are provided on the surface of the lower substrate 6 so as to oppose the black matrices 32a and 32b, respectively, to allow generation of a horizontal electric field. Further, in the display element 2 according to the present embodiment, a positive-type liquid crystal elastomer having positive dielectric anisotropy is used for the soft materials 33, and the soft materials 33 are vertically oriented through a vertically oriented film (not shown) as in Embodiment 1.

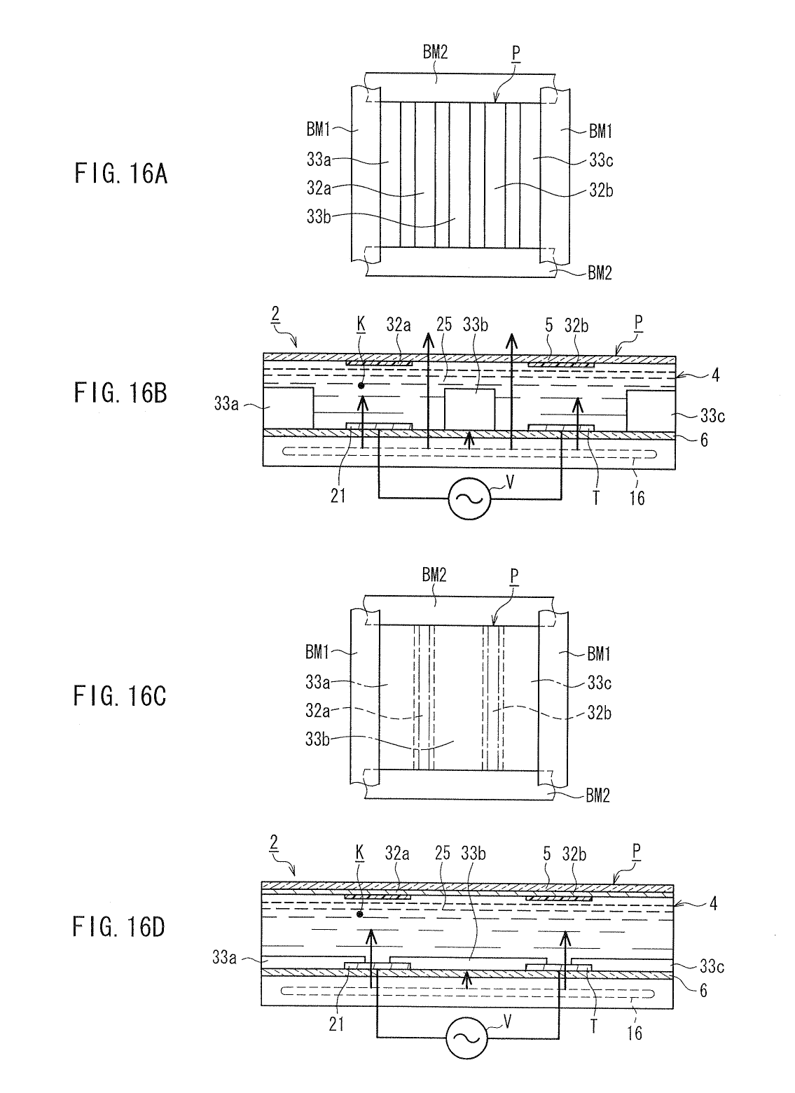

Now, the operation of the display element 2 according to the present embodiment will be described specifically with reference to FIGS. 16A to 16D.

FIGS. 16A to 16D are drawings for explaining an exemplary operation of the display element shown in FIGS. 15A and 15B. FIG. 16A is a plan view and FIG. 16B is a cross-sectional view of the principal components of the display element in the voltage-off state, and FIG. 16C is a plan view and FIG. 16D is a cross-sectional view of the principal components of the display element in the voltage-on state.

As shown in FIGS. 16A and 16B, in the display element 2 according to the present embodiment, the soft materials 33 do not expand and/or contract from the state as initially enclosed within the display space K and are retained in the initial shape in the voltage-off state, that is, when no voltage is applied to the pixel electrode 21 from the power source V provided within the source driver 18 and substantially serving as the voltage application portion. Consequently, as shown in FIGS. 16A and 16B, in the display element 2 according to the present embodiment, the black matrices 32a and 32b and the soft materials 33a to 33c are retained so as to be disposed at predetermined intervals when viewed from the display surface side (the upper substrate 5 side). As a result, in the display element 2 according to the present embodiment, illumination light from the cold cathode fluorescent tubes 16 passes through the lower substrate 6, the transparent ink 25, and the upper substrate 5 in order and is output externally as indicated by the arrows in FIG. 16B as an example. At this time, in the display element 2 according to the present embodiment, the clearance between the two soft materials 33a and 33b adjacent to the black matrix 32a and the clearance between the two soft materials 33b and 33c adjacent to the black matrix 32b become the largest, so that the display color on the display surface becomes completely white.

Further, when the power source V applies to the pixel electrode 21 the maximum voltage responsive to the gradation of a video signal as shown in FIGS. 16C and 16D, an electric field is generated between the pixel electrode 21 and the common electrode T in response to the maximum applied voltage. Consequently, as shown in FIGS. 16C and 16D, in response to the generated electric field the soft materials 33 expand and/or contract on the pixel electrode 21 in the direction parallel to the lower substrate 6. That is, as shown in FIGS. 16C and 16D, the soft material 33a alters its shape from square as shown in FIG. 16B to narrow rectangular as shown in FIG. 16D such that its right end portion is positioned below the black matrix 32a. Further, as shown in FIGS. 16C and 16D, the soft material 33b alters its shape from square as shown in FIG. 16B to narrow rectangular as shown in FIG. 16D such that its right end portion is positioned below the black matrix 32a and its left end portion is positioned below the black matrix 32b. Further, as shown in FIGS. 16C and 16D, the soft material 33c alters its shape from square as shown in FIG. 16B to narrow rectangular as shown in FIG. 16D such that its left end portion is positioned below the black matrix 32b. As a result, in the display element 2 according to the present embodiment, illumination light from the cold cathode fluorescent tubes 16 is blocked by the black matrices 32a and 32b and the soft material 33b as indicated by the arrows in FIG. 16D as an example, so that the display color on the display surface becomes completely black.

Although the description given above is directed to the case where the power supply V provided in the source driver 18 applies an alternating voltage to the pixel electrode 21, the display element 2 according to the present embodiment is not limited to such a configuration as long as an electric field can be generated between the pixel electrode (first electrode) 21 and the common electrode (second electrode) T. Thus, the display element 2 according to the present embodiment may be configured to apply voltages to both the pixel electrode 21 and the common electrode T as needed.

As a result of the configuration described above, the present embodiment can produce the same effects as those of Embodiment 1.

Further, in the display element 2 according to the present embodiment, the pixel regions P are provided in a matrix on the display surface side, and the pixel electrode (first electrode) 21 and the common electrode (second electrode) T are provided on the lower substrate 6 in each of the pixel regions P. For this reason, in the display element 2 according to the present embodiment, the soft materials 33 expand and/or contract in response to the horizontal electric field in each of the pixel regions P, so that the display color on the display surface can be changed pixel region P by pixel region P. Furthermore, in the display element 2 according to the present embodiment, the illumination light is output externally without passing through both the pixel electrode (first electrode) 21 and the common electrode (second electrode) T in contrast to the display element 2 according to Embodiment 1. Thus, in the present embodiment, the display element 2 with higher brightness can be configured easily then in Embodiment 1.

All of the embodiments described above are shown merely for an illustrative purpose and are not limiting. The technical scope of the present invention is defined by the claims, and all the changes within a range equivalent to the configuration recited in the claims also are included in the technical scope of the present invention.

For example, the descriptions given above have been directed to the case of applying the present invention to a display device provided with a display portion. However, the application of the present invention is not limited to such a display device and the present invention can be applied to any electrical device provided with a display portion that displays information including characters and images. For example, the present invention can be suitably used for electrical devices provided with a variety of display portions such as personal digital assistants including an electronic organizer, display devices for personal computers and televisions, and electronic papers.

The descriptions given above have been directed to the case where a strip-shaped black matrix, substantially frame-shaped black matrix, or black-colored soft material is used in each pixel region as a light blocking portion having a predetermined shape, and the display color on the display surface in each pixel region is changed by causing a soft material to expand and/or contract relative to the light blocking portion. However, the display element of the present invention is not limited to such a configuration as long as the display color on the display surface can be changed by causing, when an electric field is generated between the first and second electrodes, the soft material to expand and/or contract in a predetermined direction in response to the generated electric field.

However, as in each of the embodiments described above, it is preferable that a light blocking portion is provided in each pixel region and the display color on the display surface in the corresponding pixel region is changed by causing a soft material to expand and/or contract relative to the light blocking portion, because the amount of the soft material enclosed within each pixel region can be reduced, so that it is possible to reduce the thickness of the display element and the drive voltage of the soft material.

The descriptions given above have been directed to the case of configuring a transmission type display element provided with an illuminating device. However, the application of the present invention is not limited such a transmission type display element and the present invention can also be applied to a reflection type display element including a light reflection portion such as a diffuse reflection plate and to a semi-transmission type display element using the light reflection portion and an illuminating device in combination.

However, as in each of the embodiments described above, it is preferable to use an illuminating device because a transmission type display element using illumination light can be configured, whereby a display element with high brightness can be configured easily.

The descriptions given above have been directed to the case of using a liquid crystal elastomer for the soft material. However, the soft material that can be used in the display element of the present invention is not limited to a liquid crystal elastomer as long as it can be enclosed within the display space formed between the first transparent substrate and the second transparent substrate in an expandable and/or contractable manner, and when an electric field is generated between the first electrode and the second electrode it can expand and/or contract in a predetermined direction in response to the generated electric field to change the display color on the display surface.

Specifically, a polymeric gel and an electrostriction polymer (dielectric elastomer) can be used for the soft material.

The descriptions given above have been directed to the case of using a black-colored liquid crystal elastomer (soft material) and colorless transparent ink (insulating fluid) to change the display color between white and black. However, the display element of the present invention is not limited to such a configuration. Specifically, three adjacent pixel regions may be provided with color filter layers of red (R), green (G) and blue (B), respectively, on the first transparent substrate side to configure a display element that can display in full color as a result of these pixel regions.

The descriptions given above have been directed to the case where nonpolar oil is used as the transparent ink. However, the present invention is not limited to such a configuration as long as an insulating fluid unblendable with the soft material is used. For example, air may be used in place of the oil. Furthermore, silicone oil, aliphatic hydrocarbons and the like can be used as the oil.

However, as in each of the embodiments described above, it is preferable to use nonpolar oil incompatible with the soft material than to use air and a conductive liquid because it is easier for the soft material to expand and/or contract in the nonpolar oil. That is, the rate at which the soft material expands and/or contracts can be increased easily and the rate at which the display color on the display surface is changed can therefore be increased easily.

Further, the descriptions given in Embodiments 1 to 4 have been directed to the case of configuring a normally white display element by using a liquid crystal elastomer having negative dielectric anisotropy (negative-type liquid crystal elastomer). Further, the description given in Embodiment 5 has been directed to the case of configuring a normally white display element by using a liquid crystal elastomer having positive dielectric anisotropy (positive-type liquid crystal elastomer). However, the display element of the present invention is not limited to a normally white display element. By using of a positive-type or negative-type liquid crystal elastomer, a normally black display element can also be configured.

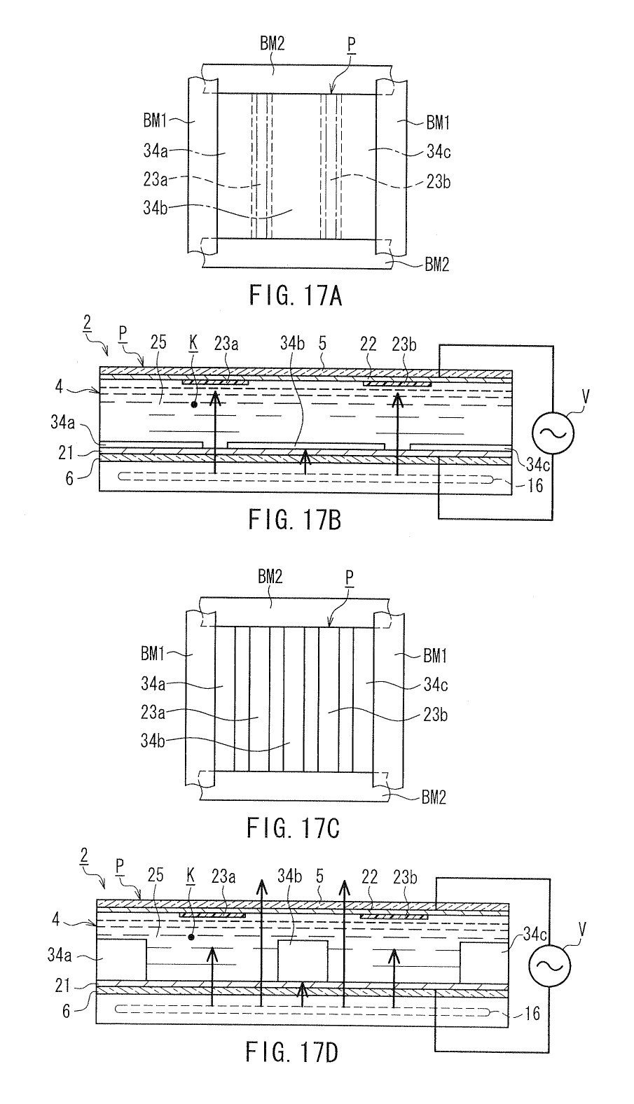

Specifically, as shown in FIGS. 17A to 17D as an example, the pixel electrode (first electrode) 21 and the counter electrode (second electrode) 22 are disposed so as to oppose each other to allow generation of a vertical electric field. Further, a positive-type liquid crystal elastomer is used for soft materials 34a, 34b and 34c (hereinafter collectively denoted by “34”) and the positive-type liquid crystal elastomer is oriented horizontally through, for example, a horizontally oriented film (not shown) by rubbing or photo-alignment so as to be parallel to the second transparent substrate 6. Furthermore, the soft materials (positive-type liquid crystal elastomer) 34 are enclosed within the display space K so as to overlap with the black matrices 23a and 23b as light blocking portions in the voltage-off state. And as shown in FIGS. 17C and 17D, the soft materials (positive-type liquid crystal elastomer) 34 expand and/or contract in a predetermined direction (i.e., the horizontal direction of the figure) such that the soft materials (positive-type liquid crystal elastomer) 34 move away from the black matrices 23a and 23b in the voltage-on state. Consequently, the display element performs black display in the voltage-off state and performs white display in the voltage-on state, thus a normally black display element is configured.

Further, in a display element in which a horizontal electric field is generated to cause the soft materials to expand and/or contract as in Embodiment 5, a negative-type liquid crystal elastomer is used for the soft materials, and the negative-type liquid crystal elastomer is oriented horizontally through, for example, a horizontally oriented film by rubbing or photo-alignment so as to be parallel to each of the first and second transparent substrates. Furthermore, the soft materials (negative-type liquid crystal elastomer) are enclosed within the display space K so as to overlap with light blocking portions in the voltage-off state. The soft materials (negative-type liquid crystal elastomer) expand and/or contract in a predetermined direction such that the soft materials (negative-type liquid crystal elastomer) move away from the light blocking portions in the voltage-on state. Consequently, the display element performs black display in the voltage-off state and performs white display in the voltage-on state, thus a normally black display element is configured.

The descriptions given above have been directed to the case where the liquid crystal elastomer is oriented vertically, radially or horizontally with the use of a vertically oriented film, conical orientation film or horizontally oriented film. However, the liquid crystal elastomer used in the present invention is not limited to such a configuration. For example, if the photopolymerizable liquid crystal monomers and the crosslinker contained in the liquid crystal elastomer are drawn in a predetermined orientation direction (to be oriented vertically, radially or horizontally) when polymerizing them under ultraviolet irradiation, the liquid crystal elastomer can be oriented vertically, radially or horizontally. Further, when the liquid crystal elastomer is oriented in this way, there is no need to use a vertically oriented film, conical orientation film or horizontally oriented film.

### INDUSTRIAL APPLICABILITY

The present invention is useful for a structurally-simple and low-cost display element that can improve the efficiency of light used for displaying, and for an electrical device using the display element.

### DESCRIPTION OF REFERENCE NUMERALS

1 display device (electrical device)
2 display element (display portion)
3 illuminating device
5 upper substrate (first transparent substrate)
6 lower substrate (second transparent substrate)
17 panel control portion (control portion)
18 source driver (voltage application portion, data line driving circuit)
20 thin film transistor (switching element)
21 pixel electrode (first electrode)
22 counter electrode (second electrode)
23a, 23b, 27a, 27b, 28, 32a, 32b black matrix (light blocking portion)
24, 24a, 24b, 24c, 29, 31, 33, 33a, 33b, 33c, 34, 34a, 34b, 34c soft material
25 transparent ink (insulating fluid)
26 liquid crystal elastomer
30a, 30b soft material (light blocking portion)
T common electrode (second electrode)
V power supply (voltage application unit)
S1 to SM source line (data line)
G1 to GN gate line (scanning line)
K display space
P pixel region
BM1, BM2 black matrix layer

1. A display element comprising:
a first transparent substrate provided on a display surface side;
a second transparent substrate provided on a non-display surface side of the first transparent substrate such that a predetermined display space is formed between the first transparent substrate and the second transparent substrate;
a first electrode and a second electrode provided on at least one of the first transparent substrate side and the second transparent substrate side;
a voltage application portion for applying a voltage to at least one of the first electrode and the second electrode such that an electric field is generated between the first electrode and the second electrode;
a soft material enclosed within the display space in an expandable and/or contractable manner, wherein when an electric field is generated between the first electrode and the second electrode the soft material expands and/or contracts in a predetermined direction in response to the generated electric field; and
a control portion for receiving an externally input instruction signal and driving the voltage application portion based on the input instruction signal,
wherein the control portion causes the soft material to expand and/or contract in the predetermined direction to change a display color on the display surface.

2. The display element according to claim 1, wherein a plurality of pixel regions are provided in a matrix on the display surface side, and
in each of the pixel regions, the first electrode is provided on one of the first transparent substrate side and the second transparent substrate side, and the second electrode is provided on the other of the first transparent substrate side and the second transparent substrate side.

3. The display element according to claim 1, wherein a plurality of pixel regions are provided in a matrix on the display surface side, and
in each of the pixel regions, the first electrode and the second electrode are provided on one of the first transparent substrate side and the second transparent substrate side.

4. The display element according to claim 2, wherein a plurality of data lines and a plurality of scanning lines are provided in a matrix on one of the first transparent substrate side and the second transparent substrate side,
each of the pixel regions is located at each of intersections of the data lines and the scanning lines, and a switching element connected to the first electrode is provided for each of the pixel regions in the vicinity of each of the intersections of the data lines and the scanning lines, and
a data line driving circuit that outputs voltage signals to the data lines in response to instruction signals from the control portion is used as the voltage application portion.

5. The display element according to claim 2, wherein black matrix layers are provided on at least one of the first transparent substrate side and the second transparent substrate side so as to separate one pixel region from the other of the pixel regions.

6. The display element according to claim 2, wherein a light blocking portion having a predetermined shape is provided in each of the pixel regions, and
by causing the soft material to expand and/or contract relative to the light blocking portion the display color on the display surface in a corresponding pixel region is changed.

7. The display element according to claim 6, wherein a strip-shaped black matrix provided parallel to a predetermined direction on one of the first transparent substrate side and the second transparent substrate side is used as the light blocking portion, and
a plurality of the soft materials are provided in each of the pixel regions such that the black matrix is interposed between the soft materials.

8. The display element according to claim 7, wherein the soft materials are provided on the same side as the strip-shaped black matrix of the first transparent substrate side and the second transparent substrate side.

9. The display element according to claim 6, wherein a substantially frame-shaped black matrix is used as the light blocking portion, the substantially frame-shaped black matrix being provided on one of the first transparent substrate side and the second transparent substrate side so as to have a circular opening having a predetermined radius about the center of a corresponding pixel region, and
the display color on the display surface in the pixel region is changed by causing the soft material to expand and/or contract concentrically about the center of the pixel region relative to the substantially frame-shaped black matrix.

10. The display element according to claim 6, wherein a black-colored soft material provided on one of the first transparent substrate side and the second transparent substrate side is used as the light blocking portion.

11. The display element according to claim 1, wherein a black-colored soft material is used as the soft material.

12. The display element according to claim 1, wherein an insulating fluid unblendable with the soft material is enclosed within the display space movably.

13. The display element according to claim 1, wherein a liquid crystal elastomer having positive dielectric anisotropy is used as the soft material.

14. The display element according to claim 1, wherein a liquid crystal elastomer having negative dielectric anisotropy is used as the soft material.

15. An electrical device comprising a display portion for displaying information including a character and an image,
wherein the display element according to claim 1 is used as the display portion.
